(19) United States
(12) Patent Application Publication
(10) Pub. No.: US 2012/0040132 A1
(43) Pub. Date: Feb. 16, 2012

(54) PROTECTIVE FILM, METHOD FOR FORMING THE SAME, SEMICONDUCTOR MANUFACTURING APPARATUS, AND PLASMA TREATMENT APPARATUS

(75) Inventors: Hideo ETO, Mie (JP); Makoto Saito, Mie (JP)

(73) Assignee: Kabushiki Kaisha Toshiba, Tokyo (JP)

(21) Appl. No.: 13/208,896

(22) Filed: Aug. 12, 2011

(30) Foreign Application Priority Data
Aug. 13, 2010 (JP) 2010-181188
Aug. 8, 2011 (JP) 2011-172820

(51) Int. Cl. B32B 3/10; B32B 3/00; C23C 28/00; C22C 21/00; C23F 1/00; B05D 5/12

(52) U.S. Cl. 428/131; 156/345.39; 427/58; 148/276; 148/437; 216/39; 428/156

(57) ABSTRACT

According to one embodiment, a protective film formed on a component in a plasma treatment apparatus and having a plasma resistance includes a base film formed on the component and having a concave-convex structure, and an upper film formed on the base film to cover the concave-convex structure.

### CROSS-REFERENCE TO RELATED APPLICATIONS

This application is based upon and claims the benefit of priority from the prior Japanese Patent Application No. 2010-181188, filed on Aug. 13, 2010 and the prior Japanese Patent Application No. 2011-172820, filed on Aug. 8, 2011; the entire contents of all of which are incorporated herein by reference.

### FIELD

Embodiments described herein relate generally to a protective film, a method for forming the same, a semiconductor manufacturing apparatus, and a plasma treatment apparatus.

### BACKGROUND

In a conventional art, in a microfabrication process for manufacturing a semiconductor device, a liquid crystal display apparatus and so forth, a RIE (reactive ion etching) apparatus is used. In the RIE apparatus, a chamber is made in a low pressure state, fluorine-based gas or chlorine-based gas is introduced into the chamber to generate a plasma phase, and etching is performed. Since a member constituting the inner wall and inner portion of the RIE apparatus is easily corroded when it is exposed to plasma, a material having a high plasma resistance such as yttria or alumina as a protective film is coated.

However, when the protective film including yttria, alumina and so forth is coated onto the member constituting the inner wall and inner portion of the RIE apparatus, the protective film may be easily stripped off if it is exposed to plasma for a long time in some places.

### BRIEF DESCRIPTION OF THE DRAWINGS

FIG. 1 is a sectional view schematically illustrating an example of the configuration of a plasma treatment apparatus;

FIGS. 2A and 2B are partial sectional views schematically illustrating the structure of a shower head according to a first embodiment;

FIG. 3 is a partial plan view schematically illustrating an example of a base film formed at a lower surface side of a shower head according to a first embodiment;

FIGS. 4A, 4B, 5A, 5B, 6A, 6B, 7A, 7B, 8A, 8B, 9A, 9B, 10A, and 10B are sectional views schematically illustrating an example of the procedure of a method for forming a protective film according to a first embodiment;

FIGS. 11A and 11B are diagrams illustrating an example of a pattern forming tool;

FIG. 12 is a sectional view schematically illustrating an example of a method for forming a pattern in resist;

FIGS. 13A to 13C are sectional views schematically illustrating the overview of the procedure of a general method for forming a protective film to a shower head;

FIGS. 14A and 14B are partial sectional views schematically illustrating the structure of a shower head according to a second embodiment;

FIGS. 15A, 15B, 16A, 16B, 17A, 17B, 18A, 18B, 19A, 19B, 20A, and 20B are sectional views schematically illustrating an example of the procedure of a method for forming a protective film according to a second embodiment;

FIGS. 21A and 21B are partial sectional views schematically illustrating the structure of a shower head according to a third embodiment;

FIGS. 22A, 22B, 23A, 23B, 24A, 24B, 25A, 25B, 26A, 26B, 27A, and 27B are sectional views schematically illustrating an example of the procedure of a method for forming a protective film according to a third embodiment;

FIG. 28 is a sectional view schematically illustrating another example of the procedure of a method for forming a protective film according to a third embodiment;

FIGS. 29A and 29B are partial sectional views schematically illustrating the structure of a shower head according to a fourth embodiment;

FIGS. 30A, 30B, 31A, 32B, 33A, 33B, 34A, 34B, 35A, and 35B are sectional views schematically illustrating an example of the procedure of a method for forming a protective film according to a fourth embodiment;

FIG. 36 is a sectional view schematically illustrating the structure of a protective film according to a fifth embodiment;

FIGS. 37A to 37E are sectional views schematically illustrating an example of the procedure of a method for forming a protective film according to a fifth embodiment;

FIG. 38 is a sectional view schematically illustrating another example of the structure of a protective film according a fifth embodiment; and

FIGS. 39A to 39E are sectional views schematically illustrating another example of the procedure of a method for forming a protective film according to a fifth embodiment.

### DETAILED DESCRIPTION

In general, according to one embodiment, a protective film is formed on a component in a plasma treatment apparatus and having a plasma resistance. The protective film includes a base film formed on the component and having a concave-convex structure, and an upper film formed on the base film to cover the concave-convex structure.

Exemplary embodiments of a protective film, a method for forming the same, a semiconductor manufacturing apparatus, and a plasma treatment apparatus will be explained below in detail with reference to the accompanying drawings. The present invention is not limited to the following embodiments. The present invention is not limited to these embodiments. Furthermore, sectional views of protective films used in the following embodiments are schematic, and relation between the thickness and width of layers and the ratio of thicknesses of the layers are not real.

### First Embodiment

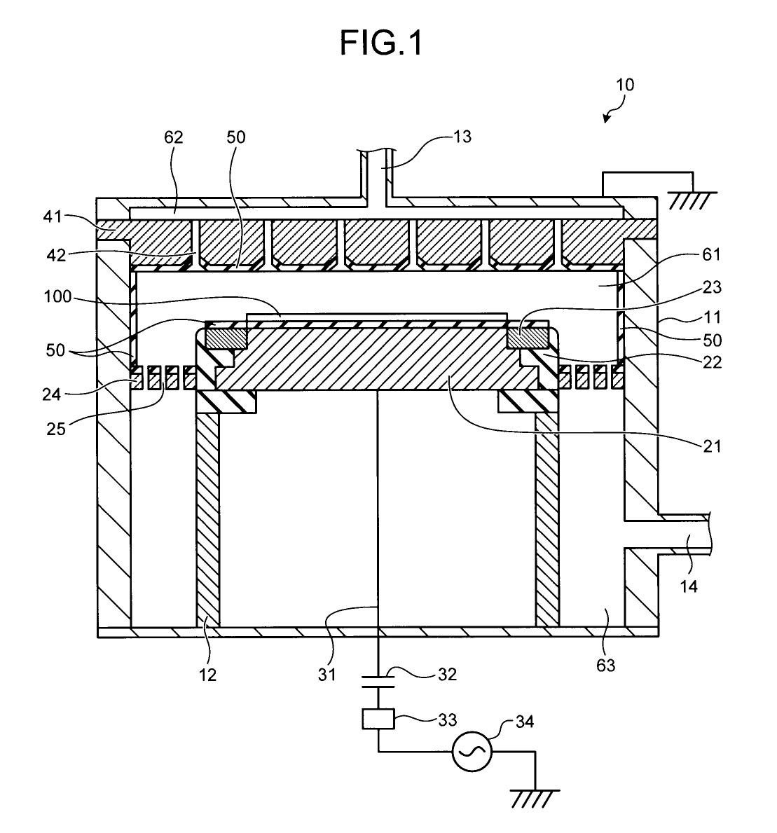

In the first embodiment, an example in which a protective film having a resistance against the exposure to plasma is applied to the inner wall of a plasma treatment apparatus will be described. FIG. 1 is a sectional view schematically illustrating an example of the configuration of a plasma treatment apparatus. Here, an RIE apparatus is used as a plasma treatment apparatus 10. The plasma treatment apparatus 10 includes a chamber 11 airtightly sealed, for example, made of aluminum. The chamber 11 is grounded.

The chamber 11 is provided therein with a support table 21 that horizontally supports a wafer 100 as a target and serves as a lower electrode. The support table 21 is provided on the surface thereof with a holding mechanism such as an electrostatic chuck mechanism (not illustrated) that electrostatically attracts the wafer 100. An insulating ring 22 is provided to cover the edges of lateral side and bottom side of the support table 21, and a focus ring 23 is provided on the outer periphery of the upper portion of the support table 21 covered by the insulating ring 22. The focus ring 23 is a member provided in order to adjust an electric field such that the electric field is not biased with respect to the vertical direction (direction vertical to a wafer surface) at the edges of the wafer 100 when the wafer 100 is etched.

Furthermore, the support table 21 is supported on a support section 12 cylindrically protruding upright from the bottom wall near the center of the chamber 11 via the insulating ring 22 such that the support table 21 is positioned near the center of the chamber 11. A baffle plate 24 is provided between the insulating ring 22 and the sidewall of the chamber 11. The baffle plate 24 is formed with a plurality of gas discharge holes 25 passing through the plate in the thickness direction of the plate. Furthermore, a power feed line 31 for supplying radio frequency power is connected to the support table 21, and a blocking condenser 32, a matching device 33, and a radio frequency power source 34 are connected to the power feed line 31. Radio frequency power with a predetermined frequency is supplied from the radio frequency power source 34 to the support table 21.

A shower head 41 serving as an upper electrode is provided above the support table 21 to face the support table 21 serving as the lower electrode. The shower head 41 is grounded. The shower head 41 is fixed to the sidewall near the upper portion of the chamber 11 while being spaced apart from the support table 21 by a predetermined distance, thereby facing the support table 21 in parallel to the support table 21. With such a structure, the shower head 41 and the support table 21 form a pair of parallel flat plate electrodes. Furthermore, the shower head 41 is formed with a plurality of gas supply passages 42 passing through the plate in the thickness direction of the plate.

A gas supply port 13 is provided near the upper portion of the chamber 11 to supply treatment gas used in plasma treatment, and a gas supply apparatus (not illustrated) is connected to the gas supply port 13 through a pipe.

A gas exhaust port 14 is provided at a lower portion of the chamber 11 below the support table 21 and the baffle plate 24, and a vacuum pump (not illustrated) is connected to the gas exhaust port 14 through a pipe.

As described above, an area of the chamber 11 partitioned by the support table 21, the baffle plate 24, and the shower head 41 becomes a plasma treatment chamber 61, an upper area of the chamber 11 partitioned by the shower head 41 is a gas supply chamber 62, and a lower area of the chamber 11 partitioned by the support table 21 and the baffle plate 24 is a gas exhaust chamber 63.

A protective film 50 is formed on the surface of a member constituting the plasma treatment apparatus 10 with such a configuration, which is in contact with a plasma generation area, that is, on the surface of a member constituting the plasma treatment chamber 61. In detail, the protective film 50 including an yttria-containing film (hereinafter, referred to as a yttria film) is formed on the inner wall surface of the chamber 11, which constitutes the plasma treatment chamber 61, the surface of the shower head 41 facing the plasma treatment chamber 61, the surface of the baffle plate 24 facing the plasma treatment chamber 61, the surface of the focus ring 23, and the surface of the support table 21 onto which the wafer 100 is loaded.

The overview of processes performed by the plasma treatment apparatus 10 configured as above will be described below. First, the wafer 100 as a target is loaded onto the support table 21, for example, the wafer 100 is fixed by the electrostatic chuck mechanism. Next, a vacuum is formed in the chamber 11 by the vacuum pump (not illustrated) connected to the gas exhaust port 14. At this time, since the gas exhaust chamber 63 and the plasma treatment chamber 61 are connected to each other through gas discharge holes 25 formed through the baffle plate 24, a vacuum is formed in the whole of the chamber 11.

Then, when the chamber 11 reaches predetermined pressure, the treatment gas is supplied from the gas supply apparatus (not illustrated) to the gas supply chamber 62, and is supplied to the plasma treatment chamber 61 through the gas supply passages 42 of the shower head 41. When pressure in the plasma treatment chamber 61 reaches predetermined pressure, a radio frequency voltage is applied to the support table 21 (the lower electrode) in the state in which the shower head 41 (the upper electrode) is grounded, so that plasma is generated in the plasma treatment chamber 61. Here, since self-bias is applied to the lower electrode due to the radio frequency voltage, potential gradient occurs between the plasma and the wafer, so that ions in plasma gas are accelerated toward the wafer 100 and thus an anisotropic etching process is performed.

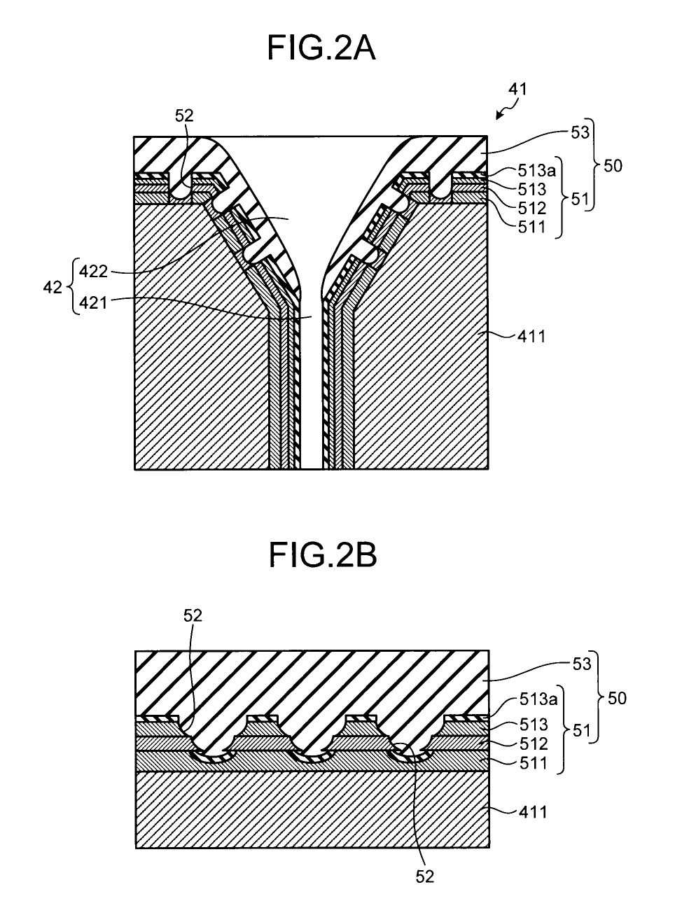

FIGS. 2A and 2B are partial sectional views schematically illustrating the structure of the shower head according to the first embodiment, wherein FIG. 2A is a sectional view schematically illustrating the structure in the vicinity of the exhaust port, and FIG. 2B is a partially enlarged sectional view of a protective film forming position. The shower head 41 (the gas supply member) is provided with the gas supply passages 42. The gas supply passages 42, for example, pass through a plate-shaped member constituting the shower head 41 toward the bottom surface from the top surface of the shower head 41 as illustrated in FIG. 1. The gas supply passage 42 includes a gas flow channel 421 with a first diameter, and an exhaust port 422 with an opening diameter increasing in a tilted manner from one end portion of the gas flow channel 421 so as to be a second diameter which is larger than the first diameter. In an example, the shower head 41 is processed to have a tapered shape in which the opening diameter of the shower head 41 increases in the vicinity of the exhaust port 422 of the gas supply passage 42.

The above-mentioned shower head 41 includes a base material 411, a base film 51 formed on an inner surface of the gas supply passage 42 of the base material 411 and a plane of a plasma-exposed side thereof, and a plasma protective film 53 which is an upper film formed on the base film 51. The protective film 50 is formed of the base film 51 and the plasma protective film 53.

The base material 411, for example, is formed of a material including aluminum (Al). The base film 51 has a function of protecting the surface of the gas flow channel 421, on which the plasma protective film 53 is hardly formed, from the exposure to plasma, wherein the surface of the base film 51 is formed of an anodic oxidation film. Furthermore, the base film 51 also has a function of preventing the base material 411 from being damaged by plasma even when the plasma protective film 53 is formed with a hole or is broken.

The plasma protective film 53 is formed of a material formed on the base film 51 and having a plasma resistance. As the plasma protective film 53, for example, an yttria film, an alumina film and so forth can be used.

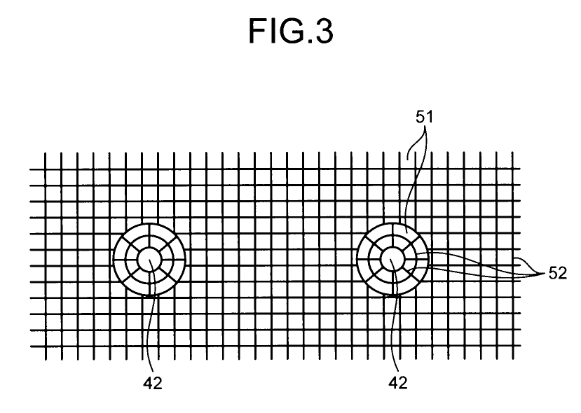

Here, the base film 51 is formed with grooves (e.g., patterns) in order to improve adhesion property to the plasma protective film 53 formed thereon. FIG. 3 is a partial plan view schematically illustrating an example of the base film formed at a lower surface side of the shower head according to the first embodiment. In the example of FIG. 3, the base film 51 is formed with adhesion property improvement grooves 52 having a lattice-shaped pattern at the lower surface side of the shower head, and a pattern radially extending from the center of the gas supply passage 42 and a concentric pattern about the gas flow channel 421 at the exhaust port 422 of the gas supply passage 42. Preferably, each adhesion property improvement groove 52 has a depth of 10 μm to 20 μm and a width of 10 μm to 20 μm, and a pitch between adjacent adhesion property improvement grooves 52 is 50 μm to 100 μm. Furthermore, since it is preferable that these patterns are formed in the base film 51, the depth of the base film 51 preferably has a depth of 20 μm or more, which is deeper than that of the pattern.

The base film 51 has a structure in which a first conductive film, a second conductive film, and a third conductive film are sequentially stacked on the base material 411, and an anodic oxidation film is formed at a contact portion to the plasma protective film 53. The first conductive film and the third conductive film are formed of a material such as aluminum (Al) or titanium (Ti), which can form an anodic oxidation film with a clear columnar structure, and the second conductive film is formed of a material with an etching rate lower than that of the first conductive film and the third conductive film at the time of a wet etching process. In the example of FIGS. 2A and 2B, the base film 51 has a structure in which an Al film 511, an Al—Si alloy film 512, and an Al film 513 are sequentially stacked on the base material 411, and an alumite film 513a is formed at a contact portion to the plasma protective film 53.

In addition, when viewed from the sectional structure of the base film 51 of FIG. 2B, an inner surface constituting the adhesion property improvement groove 52 is not formed with a continuous surface, and the Al—Si alloy film 512 with a low etching rate as compared with Al protrudes beyond the Al films 511 and 513. In detail, in the adhesion property improvement grooves 52, an opening of the upper surface of the Al film 511 is formed larger in diameter than an opening of the lower surface of the Al—Si alloy film 512, and an opening of the lower surface of the Al film 513 is formed larger in diameter than an opening of the upper surface of the Al—Si alloy film 512, resulting in an increase in the surface area of the base film 51 formed with the adhesion property improvement grooves 52 and an anchor effect due to the shape, and the improvement of adhesion property to the base film 51 of the plasma protective film 53 formed on the base film 51. Furthermore, the Al films 511 and 513 being in contact with the plasma protective film 53 is provided with the alumite film 513a.

In addition, an adhesion property improvement effect is basically achieved regardless of the type of the pattern of the adhesion property improvement groove 52. However, it is preferable that a pattern formed on a surface constituting the exhaust port 422 of the gas supply passage 42 is a radial pattern. FIG. 3 illustrates an example in which a radial pattern and a concentric pattern are formed on the surface constituting the exhaust port 422 of the gas supply passage 42. However, only the radial pattern may be formed.

Next, a method for forming the protective film 50 to the shower head 41 will be described. FIGS. 4A, 4B, 5A, 5B, 6A, 6B, 7A, 7B, 8A, 8B, 9A, 9B, 10A, and 10B are sectional views schematically illustrating an example of the procedure of a method for forming the protective film according to the first embodiment. Among these drawings, FIGS. 4A, 5A, 6A, 7A, 8A, 9A, and 10A are sectional views in the vicinity of the shower head, and FIGS. 4B, 5B, 6B, 7B, 8B, 9B, and 10B are enlarged sectional views of protective film forming positions.

First, as illustrated in FIGS. 4A and 4B, for example, the gas supply passage 42 is formed in the base material 411 formed of aluminum. As described above, the gas supply passage 42 includes the gas flow channel 421 with a first diameter, and the exhaust port 422 with an opening diameter increasing in a tilted manner from one end portion of the gas flow channel 421 so as to be a second diameter which is larger than the first diameter.

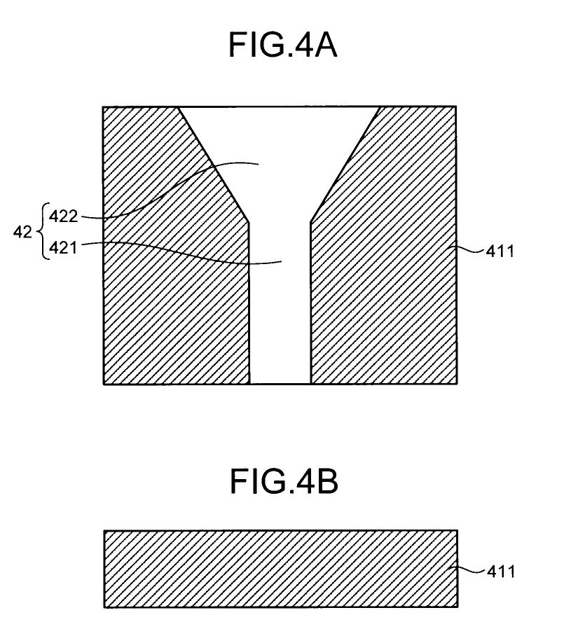

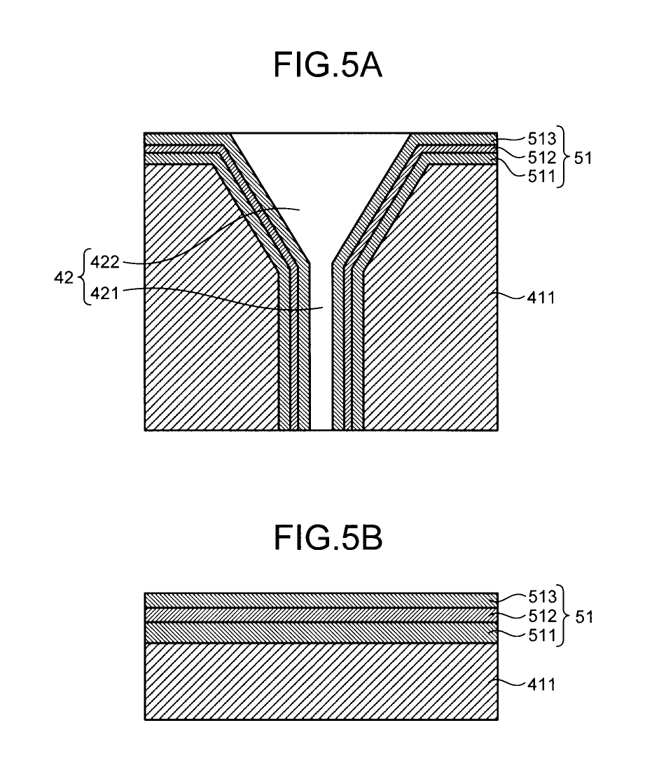

Next, as illustrated in FIGS. 5A and 5B, the base film 51 is formed on the surface of a plasma-exposed side of the base material 411. Here, as the base film 51, the Al film 511, the Al—Si alloy film 512, and the Al film 513 are formed on the base material 411 using a deposition method. The Al—Si alloy film 512 has an etching rate lower than those of the Al films 511 and 513 at the time of a subsequent wet etching process. Furthermore, the thicknesses of the Al film 511, the Al—Si alloy film 512, and the Al film 513, for example, may be 7 μm. In addition, the base film 51 may be formed using methods other than the deposition method, for example, a sputtering method and so forth. However, in order to form the base film 51 on the surface of the gas flow channel 421 formed perpendicularly to the surface of the base material 411, it is preferable to use a film forming method (e.g., a deposition method) having an excellent step coverage.

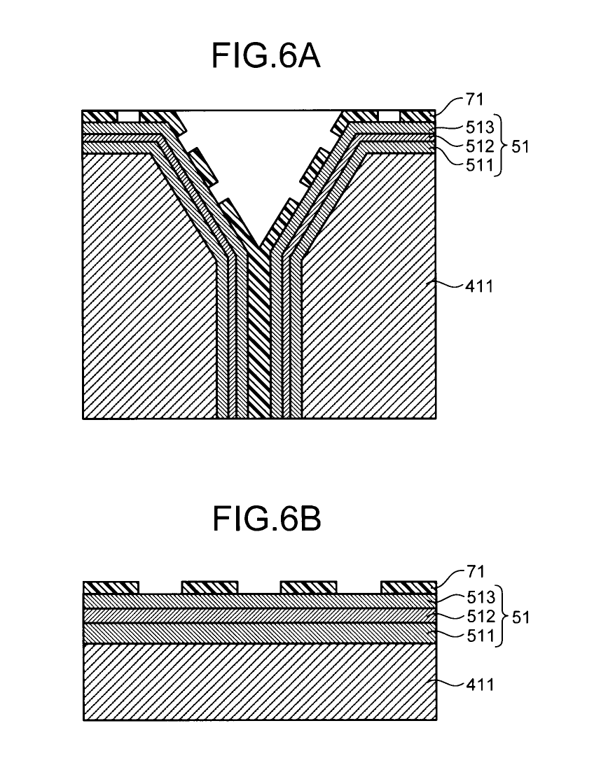

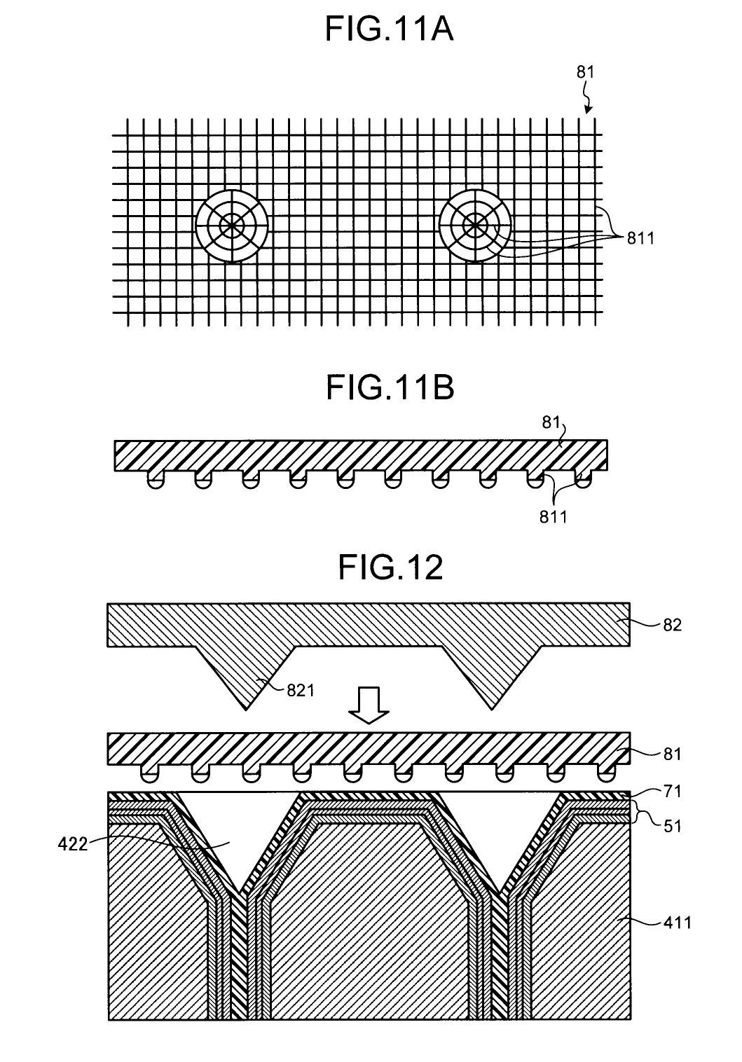

Then, as illustrated in FIGS. 6A and 6B, resist 71 is patterned in a predetermined shape on the base film 51. At this time, the resist 71 is formed to be embedded in the gas supply passage 42. FIGS. 11A and 11B are diagrams illustrating an example of a pattern forming tool, wherein FIG. 11A illustrates a plan view thereof and FIG. 11B illustrates a partially enlarged sectional view thereof. A pattern forming tool 81 forms grooves with a lattice-shaped pattern in the resist 71 positioned at the formation surface side of the exhaust port of the base material 411, and includes a pattern 811 capable of forming grooves with a pattern, which radially extends from the center of the exhaust port 422, in the resist 71 on the exhaust port 422, and a pattern arranged concentrically to the center of the exhaust port 422. The pattern forming tool 81, for example, is formed of an elastic material such as rubber.

FIG. 12 is a sectional view schematically illustrating an example of a method for forming a pattern in resist. As illustrated in FIG. 12, the pattern forming tool 81 is arranged above the exhaust port formation surface of the base material 411 coated with the resist 71 through positioning. Then, the rear surface of the pattern forming tool 81 is pressed by a pressing tool 82 and the resist is solidified, thereby forming a pattern in the resist 71. The pressing tool 82 is provided with a protrusion part 821 corresponding to the shape of the exhaust port 422 at the formation position of the exhaust port 422 of the base material 411, and is formed of a material (e.g., a metal) having stiffness. If the pattern forming tool 81 is pressed by the pressing tool 82, since the pattern forming tool 81 is formed of an elastic material, the pattern forming tool 81 is deformed according to the shape of the base material 411, so that a pattern with lattice-shaped grooves is formed in the resist 71 on the plane of the exhaust port formation side of the base material 411, and a pattern with radial and concentric grooves is formed in the resist 71 on the exhaust port 422. Here, the pattern (an area not coated with the resist 71) with the grooves is formed with a width of 10 μm to 20 μm and a pitch of 50 μm to 100 μm. So far, a pattern formation method using transfer has been described. However, the pattern may be formed using a photolithography method, a laser drawing method, an imprinting method and so forth.

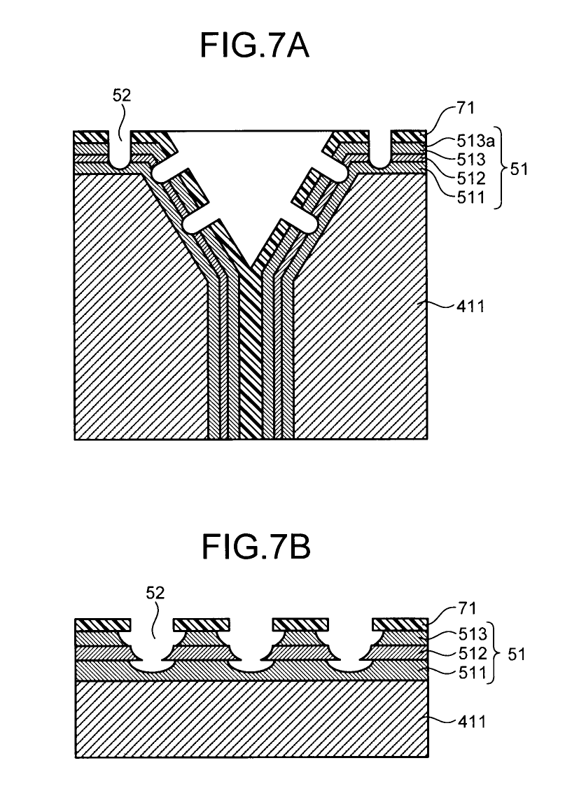

Thereafter, as illustrated in FIGS. 7A and 7B, the base film 51 is etched using the patterned resist 71 as a mask through a wet etching process, thereby forming the adhesion property improvement grooves 52 in the base film 51. As an etchant, for example, it is possible to use an alkali solution and so forth, such as mixed acid formed of phosphoric acid, nitric acid, acetic acid and water, sodium hydroxide, potassium hydroxide, or TMAH (Tetramethylammonium hydroxide). Furthermore, an etching time is controlled such that the base material 411 is not etched.

First, the uppermost Al film 513 not coated with the resist 71 is isotropically etched. As the Al film 513 is etched, if the Al—Si alloy film 512 is exposed at the lower portion of the Al film 513, the Al—Si alloy film 512 is isotropically etched. In addition, as the Al—Si alloy film 512 is etched, if the Al film 511 is exposed at the lower portion of the Al—Si alloy film 512, the Al film 511 is isotropically etched. Since each film is isotropically etched until the depths of the adhesion property improvement grooves 52 reach a predetermined depth, the Al film 513 is side-etched. Furthermore, since the Al—Si alloy film 512 has a low etching rate as compared with the Al film 511, the uppermost Al film 511 is also side-etched. As a consequence, the Al—Si alloy film 512 protrudes beyond the upper and lower Al films 513 and 511. That is, an opening of the upper surface of the uppermost Al film 511 is formed larger in diameter than an opening of the lower surface of the Al—Si alloy film 512, and an opening of the lower surface of the uppermost Al film 513 is formed larger in diameter than an opening of the upper surface of the Al—Si alloy film 512. In this way, a concave-convex structure having an anchor shape is formed on the inner surface of the adhesion property improvement groove 52, resulting in an increase of adhesion caused by an increase of a shape effect and a surface area.

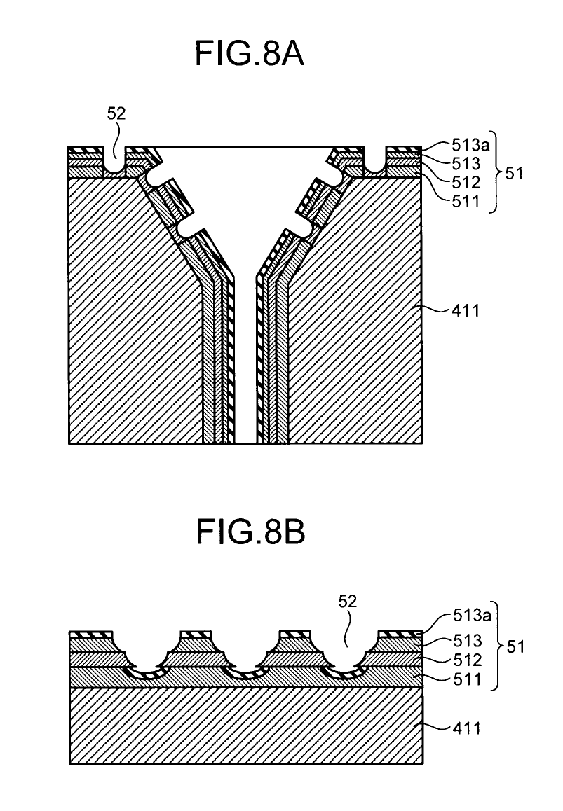

After the resist 71 is stripped, an anodic oxidation process is performed on the Al films 511 and 513 of the base film 51 as illustrated in FIGS. 8A and 8B. In this way, the alumite film 513a is formed in an area where the Al films 511 and 513 are exposed. At this time, the Al film 513 of the base film 51, which is formed on the inner surface of the gas flow channel 421, is also anodically oxidized, so that the upper surface of the Al film 513 becomes the alumite film 513a.

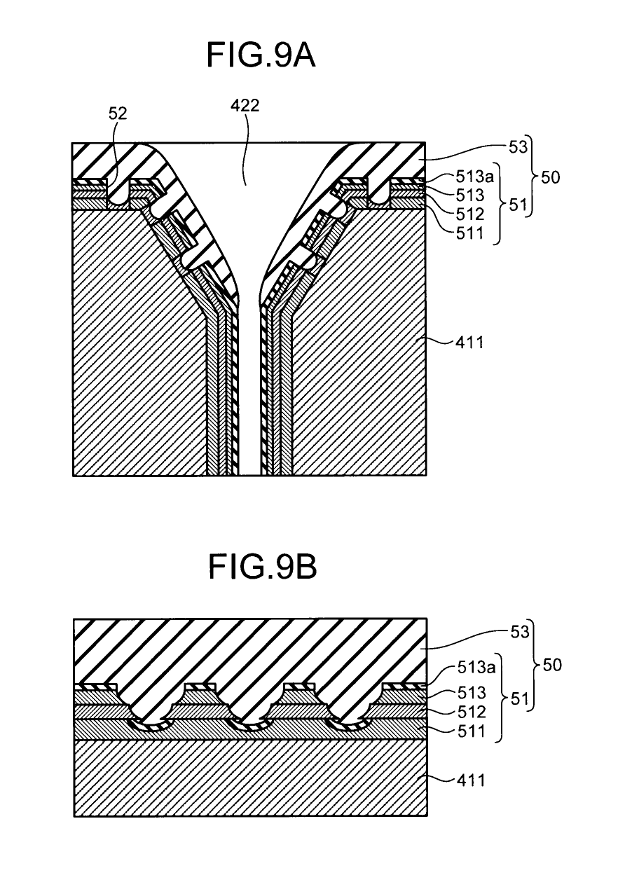

Then, as illustrated in FIGS. 9A and 9B, the plasma protective film 53 is formed on the inner surface of the exhaust port 422 and the base film 51 of the exhaust port formation surface of the base material 411. As the plasma protective film 53, an alumina film, an yttria film and so forth can be used. Furthermore, as a method for forming the plasma protective film 53, for example, it is possible to use a spraying method, a CVD (Chemical Vapor Deposition) method, an aerosol deposition method, a cold spraying method, a gas deposition method, an electrostatic powder impact deposition method, an impact sintering method and so forth. Here, the plasma protective film 53 is also embedded in the adhesion property improvement grooves 52 formed in the base film 51. Since the surface area of the adhesion property improvement grooves 52, for example, is increased as compared with the case in which the base film 51 is formed using one layer of an Al film, adhesion property of the plasma protective film 53 to the base film 51 is increased by an anchor effect. With the above-mentioned processes, it is possible to obtain the shower head 41 in which the protective film 50 according to the first embodiment has been formed on the base material 411.

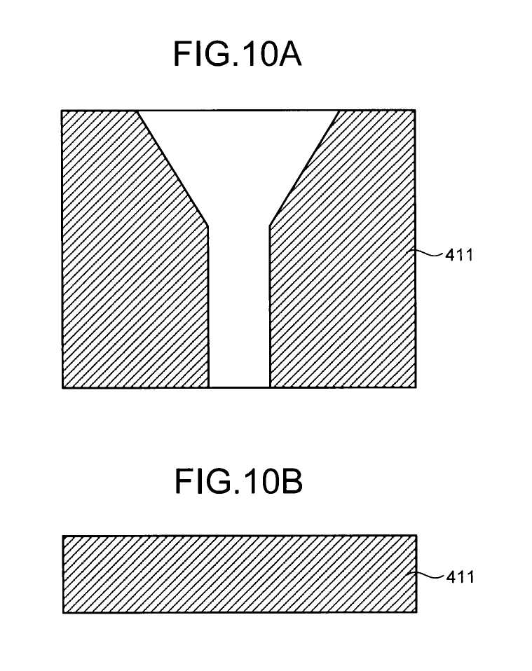

In addition, if the shower head 41 formed in this way is used in the plasma treatment apparatus illustrated in FIG. 1 for a long time, the protective film 50 may deteriorate due to plasma damage. Therefore, when the protective film 50 deteriorates, the protective film 50 is removed as illustrated in FIGS. 10A and 10B. That is, the plasma protective film 53 and the base film 51 are stripped off using a lift-off method to expose the base material 411. Then, the protective film 50 can be formed (re-coated) on the base material 411 again using the method illustrated in FIGS. 5A, 5B, 6A, 6B, 7A, 7B, 8A, 8B, 9A, and 9B. In addition, in the method according to the first embodiment, since an etching process is controlled such that the adhesion property improvement grooves 52 illustrated in FIGS. 7A and 7B do not reach the base material 411, the base material 411 is prevented from being damaged, and the protective film 50 is re-coated, so that the base material 411 can be repeatedly used and the lifespan of the shower head 41 can be extended.

So far, the example has been described, in which three layers of the Al film 511, the Al—Si alloy film 512, and the Al film 513 are stacked on the base material 411 as the base film 51. However, the base film 51 may have a structure in which a plurality of Al films and a plurality of Al—Si alloy films are alternately stacked. Furthermore, the base film 51 may have a structure in which a single Al film 511 is formed on the base material 411.

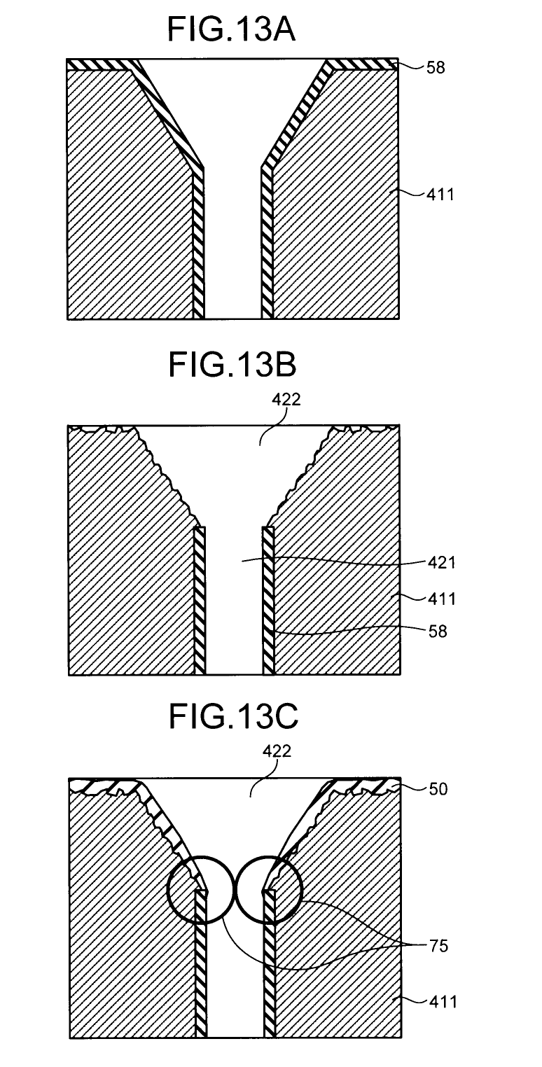

Hereinafter, the effect of the first embodiment will be described in comparison with a comparative example. FIGS. 13A to 13C are sectional views schematically illustrating the overview of the procedure of a general method for forming a protective film to a shower head. In general, in order to form the protective film 50 on the gas supply passages 42 of the shower head 41, the surface of the base material 411 formed of Al is subject to an anodic oxidation process to from an alumite film 58 as illustrated in FIG. 13A. Next, as illustrated in FIG. 13B, the surface of the alumite film 58 is stripped off using a sandblasting method. As a consequence, the alumite film 58 is provided on the surface thereof with a concave-convex structure. Then, as illustrated in FIG. 13C, the protective film 50 is formed on the surface of the base material 411 provided with the concave-convex structure. In this way, the protective film 50 is formed on the base material 411 provided with the concave-convex structure, resulting in an increase of adhesion strength of the protective film 50.

However, it is difficult to uniformly roughen the surface of the exhaust port 422 with a tapered shape by using the sandblast method. Specifically, a smaller concave-convex structure is formed on the exhaust port 422, which is near the gas flow channel 421, as compared with the plane of the exhaust port formation side of the base material 411. As a consequence, the protective film 50 formed on the exhaust port 422 in the vicinity of the gas flow channel 421 has poor adhesion property to the base material 411. In such a state, if the protective film 50 is subject to plasma treatment, since a crack may be generated in corners 75 at the boundaries between the gas flow channel 421 and the exhaust port 422, the protective film 50 may be stripped off and the stripped film may fall on a wafer to be subject to plasma treatment as dust.

Meanwhile, in the first embodiment, the adhesion property improvement grooves 52 are formed in the base film 51, in which the Al film 511, the Al—Si alloy film 512, and the Al film 513 are stacked, which have been formed on the exhaust port 422 with a tapered shape of the gas supply passages 42 of the base material 411, and the Al—Si alloy film 512 has a sectional structure in which the Al—Si alloy film 512 protrudes beyond the Al films 511 and 513. Furthermore, since the adhesion property improvement grooves 52 are formed using a lithography technique and an etching technique, even when the adhesion property improvement grooves 52 are positioned on a plane of the exhaust port formation side of the base material 411 or positioned adjacent to the gas flow channel 421 of the exhaust port 422, the depths of the grooves are approximately constant, resulting in the achievement of uniform roughness. Consequently, adhesion property between the base film 51 and the plasma protective film 53 formed on the base film 51 is improved by an anchor effect. As a consequence, even when heat is repeatedly applied through plasma treatment, the plasma protective film 53 formed in the vicinity of the gas flow channel 421 of the exhaust port 422 is hardly stripped off.

Furthermore, a pattern (the adhesion property improvement groove 52) may be directly formed on the base material 411 without forming the base film 51, and the plasma protective film 53 may be formed on the pattern. However, in such a case, since the surface area of the adhesion property improvement grooves 52 is not increased different from the first embodiment, the plasma protective film 53 may be easily stripped off as compared with the first embodiment. Therefore, as described above, it is preferable to use the base film 51 in which a metal film (e.g., the Al film 511/the Al—Si alloy film 512/the Al film 513) for allowing an anodic oxidation film to be easily formed, and a material film, which is hardly etched as compared with the metal film at the time of an etching process, are stacked on the base material 411.

Moreover, after the Al film 513 of the base film 51 formed in the gas flow channel 421 of the base material 411 is anodically oxidized to form the alumite film 513a, the plasma protective film 53 is formed on the base film 51 formed on the surface, which constitutes the exhaust port 422, and a main surface of the exhaust port formation surface side of the base material 411. Consequently, it is possible to form a film having a plasma resistance on the inner surface of the gas flow channel 421 on which the plasma protective film 53 is hardly formed. Moreover, as with the comparative example, the base film 51 may not be removed, which has been formed on a formation area of the plasma protective film 53, that is, the surface constituting the exhaust port 422, and the main surface of the exhaust port formation surface side of the base material 411.

### Second Embodiment

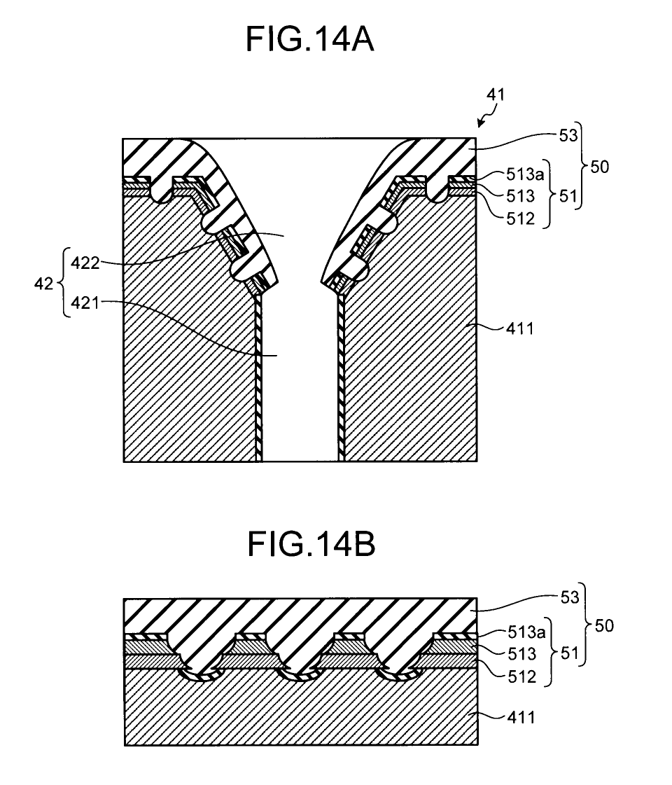

FIGS. 14A and 14B are partial sectional views schematically illustrating the structure of the shower head according a second embodiment, wherein FIG. 14A is a sectional view schematically illustrating the structure in the vicinity of the exhaust port, and FIG. 14B is a partially enlarged sectional view of a protective film forming position. The first embodiment uses the base film obtained by sequentially stacking the Al film, the Al—Si alloy film, and the Al film on the base material. However, in the second embodiment, since the base material 411 is made of a material including Al, the base film 51 is obtained by sequentially stacking the Al—Si alloy film 512 and the Al film 513 on the base material 411. That is, the second embodiment has a structure in which the base material 411 is used as the lowermost Al film 511 of the base film 51 in the first embodiment. Therefore, the adhesion property improvement grooves 52 reach the base material 411 and the plasma protective film 53 makes contact with the base material 411. In addition, the same reference numerals are used to designate the same elements as those of the first embodiment, detailed description thereof will not be repeated.

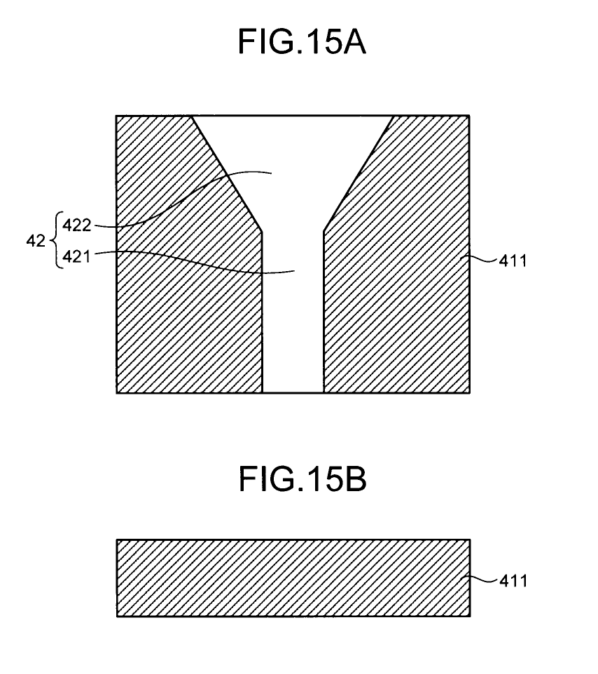

FIGS. 15A, 15B, 16A, 16B, 17A, 17B, 18A, 18B, 19A, 19B, 20A, and 20B are sectional views schematically illustrating an example of the procedure of a method for forming the protective film according to the second embodiment. Among these drawings, FIGS. 15A, 16A, 17A, 18A, 19A, and 20A are sectional views in the vicinity of the shower head, and FIGS. 15B, 16B, 17B, 18B, 19B, and 20B are enlarged sectional views of protective film forming positions.

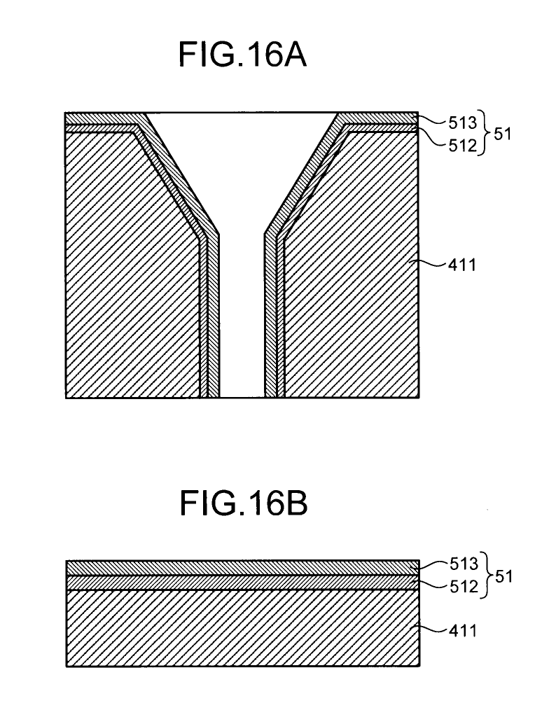

First, as illustrated in FIGS. 15A and 15B, for example, the gas supply passage 42 including the gas flow channel 421 and the exhaust port 422 connected to the gas flow channel 421 is formed in the base material 411 formed of aluminum. Next, as illustrated in FIGS. 16A and 16B, the base film 51 is formed on the surface of a plasma-exposed side of the base material 411. Here, as the base film 51, the Al—Si alloy film 512 and the Al film 513 are formed on the base material 411 using a deposition method. The Al—Si alloy film 512 has an etching rate lower than that of the Al film 513 at the time of a subsequent wet etching process. Furthermore, the thicknesses of the Al—Si alloy film 512 and the Al film 513, for example, may be 1 μm, which is thinner than the first embodiment.

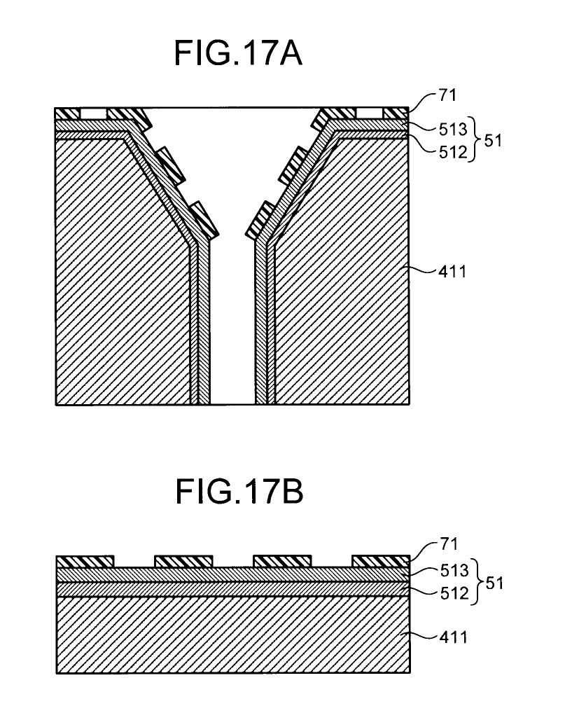

Then, as illustrated in FIGS. 17A and 17B, the resist 71 is patterned in a predetermined shape on the base film 51 in the same manner as the first embodiment. A pattern with lattice-shaped grooves is formed in the resist 71 on the exhaust port formation surface side of the base material 411, and a pattern with radial and concentric grooves is formed in the resist 71 on the exhaust port 422. Here, the pattern (an area not coated with the resist 71) with the grooves is formed with a width of 10 μm to 20 μm and a pitch of 50 μm to 100 μm.

Thereafter, as illustrated in FIGS. 18A and 18B, the base film 51 is etched using the resist pattern as a mask through a wet etching process, thereby forming the adhesion property improvement grooves 52 in the base film 51. As an etchant, for example, it is possible to use mixed acid, which is formed of phosphoric acid, nitric acid, acetic acid and water, and so forth similarly to the first embodiment.

First, the uppermost Al film 513 not coated with the resist 71 is isotropically etched. As the Al film 513 is etched, if the Al—Si alloy film 512 is exposed at the lower portion of the Al film 513, the Al—Si alloy film 512 is isotropically etched. In addition, as the Al—Si alloy film 512 is etched, if the base material 411 formed of a material including Al is exposed at the lower portion of the Al—Si alloy film 512, the base material 411 is isotropically etched. Since each film and the base material 411 are isotropically etched until the depths of the adhesion property improvement grooves 52 reach a predetermined depth, the Al film 513 is side-etched. Furthermore, since the Al—Si alloy film 512 has a lower etching rate as compared with Al, the base material 411 is also side-etched. As a consequence, the Al—Si alloy film 512 protrudes beyond the Al film 513 and the base material 411. That is, an opening of the upper surface of the base material 411 is formed larger in diameter than an opening of the lower surface of the Al—Si alloy film 512, and an opening of the lower surface of the uppermost Al film 513 is formed larger in diameter than an opening of the upper surface of the Al—Si alloy film 512. In this way, a concave-convex structure having an anchor shape is formed on the inner surface of the adhesion property improvement groove 52, resulting in an increase of adhesion caused by an increase of a shape effect and a surface area. Furthermore, the base film 51 which has been formed on the inner surface of the gas flow channel 421 having no resist 71, and a part of the base material 411 is removed by the etching process.

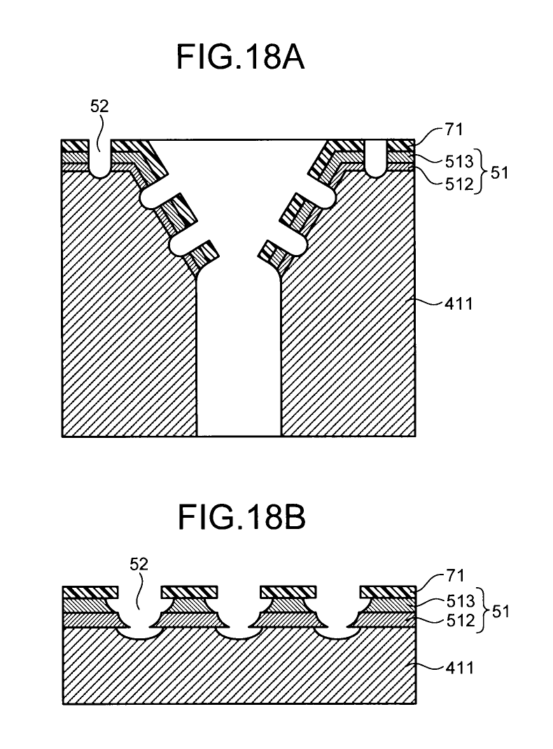

After the resist 71 is stripped off, an anodic oxidation process is performed on the Al film 513 of the base film 51 and the base material 411 as illustrated in FIGS. 19A and 19B. In this way, the alumite film 513a is formed in an area where the Al film 513 and the base material 411 are exposed.

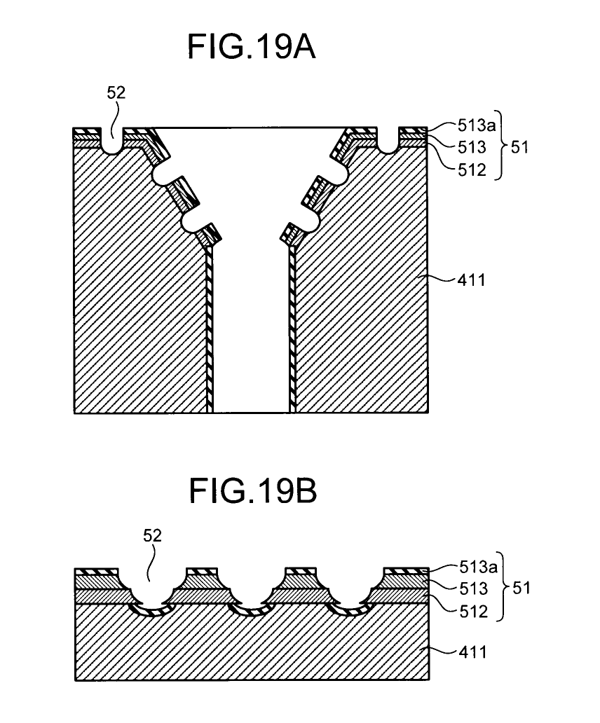

Then, as illustrated in FIGS. 20A and 20B, the plasma protective film 53 such as an alumina film or an yttria film is formed on the inner surface of the exhaust port 422 and the base film 51 of the exhaust port formation surface of the base material 411. As a method for forming the plasma protective film 53, for example, it is possible to use a spraying method, a CVD method, an aerosol deposition method, a cold spraying method, a gas deposition method, an electrostatic powder impact deposition method, an impact sintering method and so forth. The plasma protective film 53 is also embedded in the adhesion property improvement grooves 52, resulting in an increase of adhesion property between the adhesion property improvement grooves 52 and the base film 51 by an anchor effect. With the above-mentioned processes, it is possible to obtain the shower head 41 in which the protective film 50 according to the second embodiment has been formed on the base material 411.

Even in the second embodiment, similarly to the first embodiment, even when the plasma treatment is repeated and the plasma protective film 53 is exposed to plasma, it is possible to obtain the plasma protective film 53 which is hardly stripped off from the base material 411.

### Third Embodiment

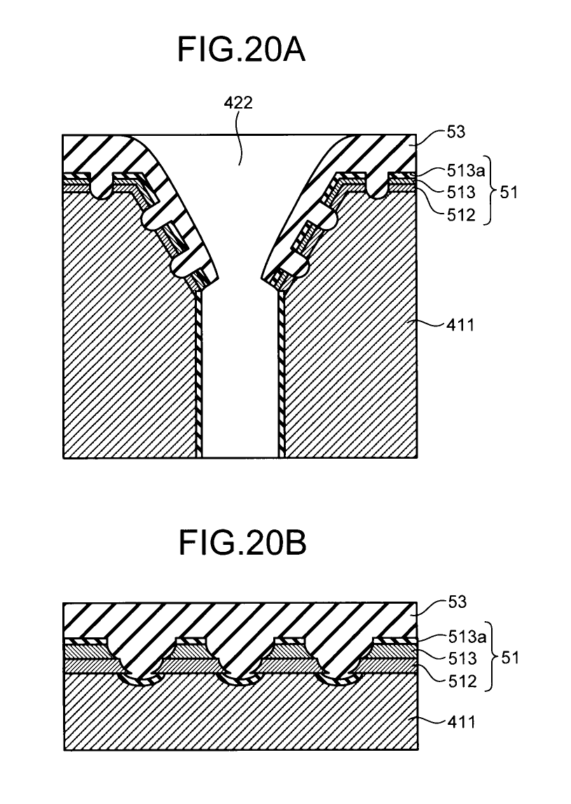

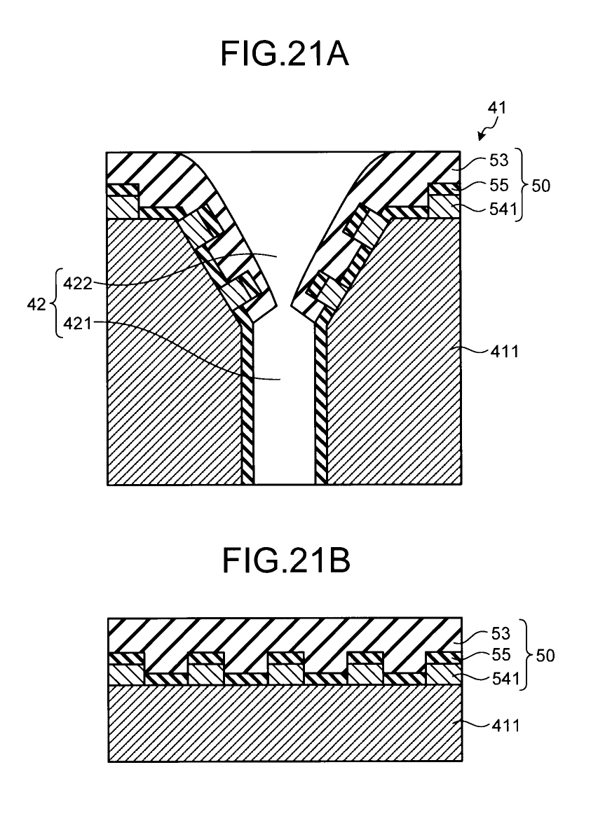

FIGS. 21A and 21B are partial sectional views schematically illustrating the structure of the shower head according a third embodiment, wherein FIG. 21A is a sectional view schematically illustrating the structure in the vicinity of the exhaust port, and FIG. 21B is a partially enlarged sectional view of a protective film forming position. Low melting point alloy crystal grains 541 formed of an alloy of Al and a low melting point metal and having a height of about 10 μm to about 20 μm are formed to be dispersed on the exhaust port formation surface of the base material 411 and the inner surface of the exhaust port 422, which constitute the shower head 41.

Furthermore, an alumite base film formed of an alumite film is formed on the surface of the low melting point alloy crystal grains 541 and the surface (includes the inner surface of the gas flow channel 421 of the base material 411) of the base material 411 with no low melting point alloy crystal grains 541 being formed. In addition, the plasma protective film 53 formed of alumina and yttria is formed on the exhaust port formation surface of the base material 411 and the alumite base film of the exhaust port 422.

That is to say, in the third embodiment, the low melting point alloy crystal grains 541 are formed to be dispersed on the exhaust port formation surface of the base material 411 and the inner surface of the exhaust port 422, resulting in an increase of the surface area of the base material 411, and the achievement of an anchor effect for the plasma protective film 53 formed on the base material 411.

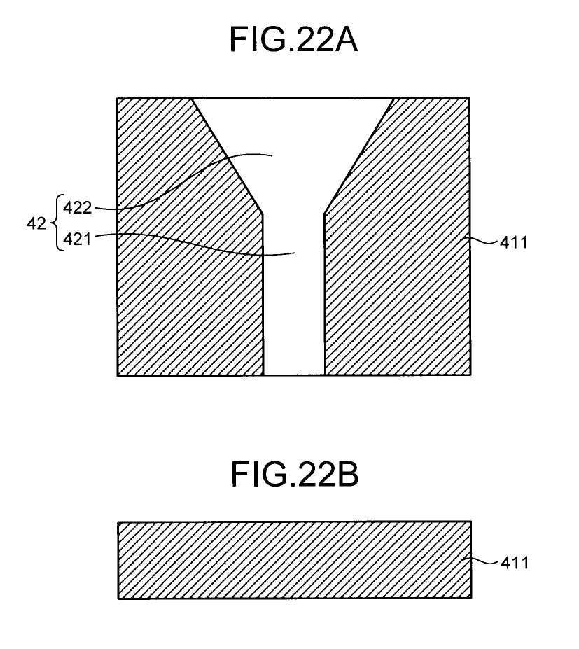

FIGS. 22A, 22B, 23A, 23B, 24A, 24B, 25A, 25B, 26A, 26B, 27A, and 27B are sectional views schematically illustrating an example of the procedure of a method for forming the protective film according to the third embodiment. Among these drawings, FIGS. 22A, 23A, 24A, 25A, 26A, and 27A are sectional views in the vicinity of the shower head, and FIGS. 22B, 23B, 24B, 25B, 26B, and 27B are enlarged sectional views of protective film forming positions.

First, as illustrated in FIGS. 22A and 22B, for example, the gas supply passage 42 including the gas flow channel 421 and the exhaust port 422 connected to the gas flow channel 421 is formed in the base material 411 formed of aluminum. Next, as illustrated in FIGS. 23A and 23B, a seal material 72 is filled in the gas flow channel 421 of the gas supply passage 42. The seal material 72 is filled only in the gas flow channel 421, and is not embedded in the exhaust port 422. Furthermore, as the seal material 72, for example, resist can be used.

Then, an aluminum alloy film 54a having a low melting point of about 200° C. is deposited with a predetermined thickness (e.g., 20 μm) on the surface of the exhaust port formation surface side of the base material 411, in detail, the exhaust port formation surface of the base material 411, the inner surface of the exhaust port 422, and the upper surface of the seal material 72. As the aluminum alloy film 54a, for example, Al—Sn, Al—Pb, Al—In and so forth can be used. The aluminum alloy film 54a is in an amorphous state immediately after being deposited.

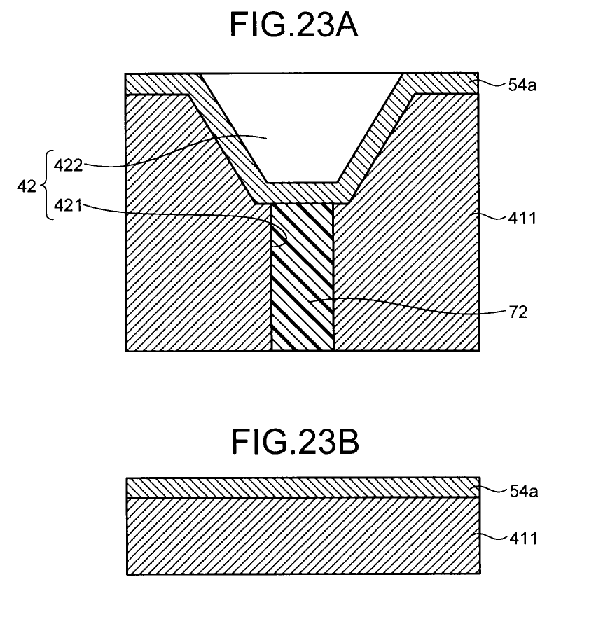

Then, as illustrated in FIGS. 24A and 24B, heat treatment is performed with respect to the base material 411 at the temperature of about 200° C. Thus, the aluminum alloy film 54a in the amorphous state is crystallized. If the aluminum alloy film 54a is crystallized, low melting point metal components (e.g., Sn, Pb, In and so forth) having a melting point of 350° C. or less are segregated, resulting in the formation of an aluminum alloy film 54 in which the low melting point alloy crystal grains 541 including low melting point metals are dispersed among Al crystal grains 542 including no low melting point metals.

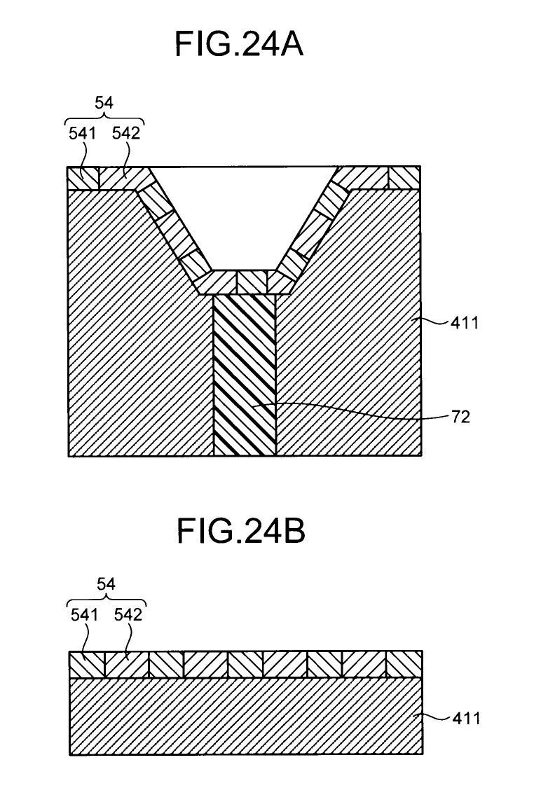

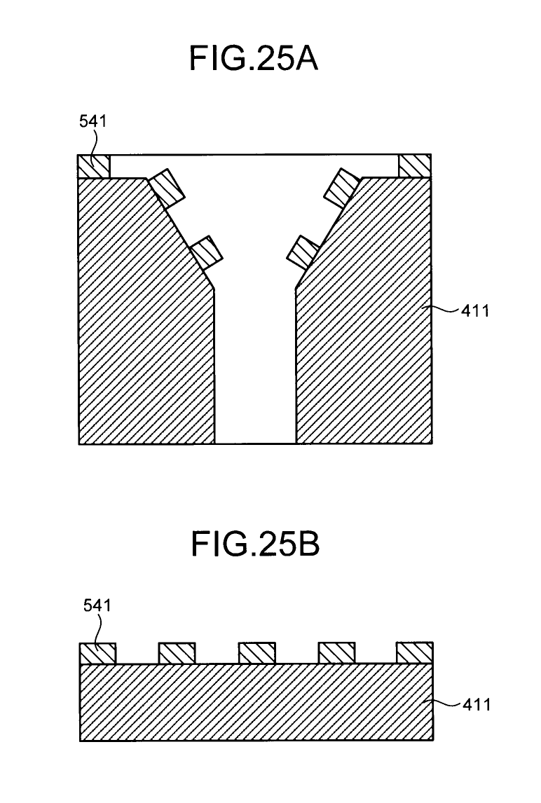

Thereafter, as illustrated in FIGS. 25A and 25B, a wet etching process is performed, so that crystal grains including no low melting point metals, that is, the Al crystal grains 542 are removed, and the low melting point alloy crystal grains 541 remain. An etchant uses chemical that dissolves the Al crystal grains 542 but does dot dissolve the low melting point alloy crystal grains 541, and for example, may use mixed acid formed of phosphoric acid, nitric acid, acetic acid and water similarly to the first embodiment. In addition, in this wet etching process, the Al crystal grains 542 of the aluminum alloy film 54 may be removed. Through the etching process, the low melting point alloy crystal grains 541 with a height of 10 μm to 20 μm are randomly arranged on the lower surface of the base material 411 and the inner surface of the exhaust port 422. In this way, the low melting point alloy crystal grains 541 are arranged on the base material 411, so that a concave-convex structure is formed on the surface of the base material 411 serving as a base film of the plasma protective film 53. In addition, the low melting point alloy crystal grains 541 on the seal material 72 are removed by lift-off when removing the seal material 72.

Next, as illustrated in FIGS. 26A and 26B, an anodic oxidation process is performed with respect to the base material 411 and the low melting point alloy crystal grains 541. In this way, an alumite base film 55 is formed on exposed areas of the base material 411 and the low melting point alloy crystal grains 541. At this time, the alumite base film 55 is formed on the inner surface of the gas flow channel 421 of the gas supply passage 42, in which the plasma protective film 53 is hardly formed.

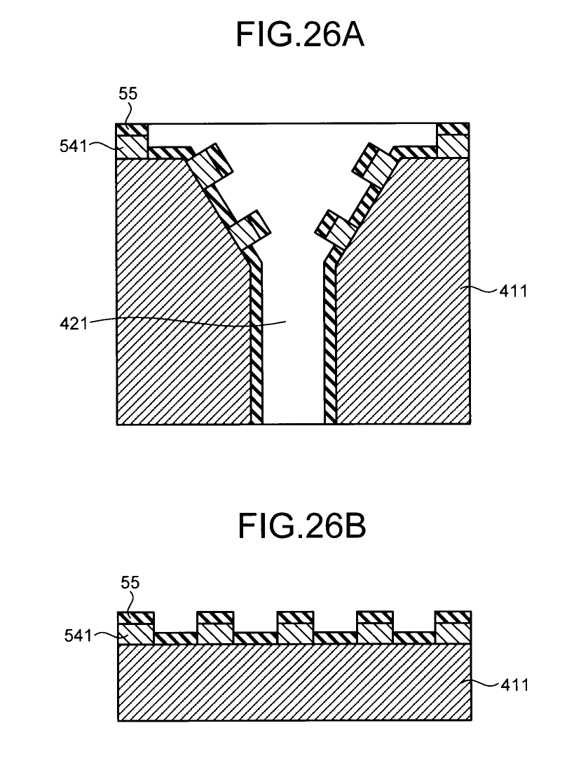

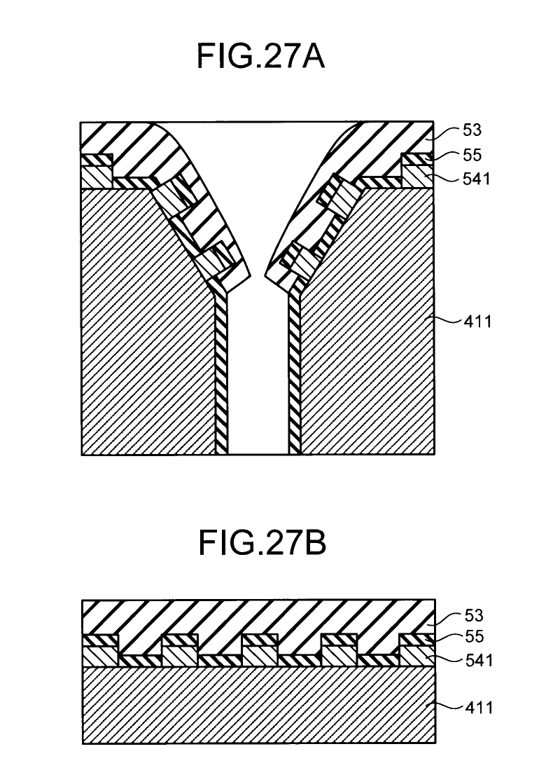

Thereafter, as illustrated in FIGS. 27A and 27B, the plasma protective film 53 such as an alumina film or an yttria film is formed on the inner surface of the exhaust port 422, on which the low melting point alloy crystal grains 541 have been formed, and the exhaust port formation surface of the base material 411. As a method for forming the plasma protective film 53, for example, it is possible to use a spraying method, a CVD method, an aerosol deposition method, a cold spraying method, a gas deposition method, an electrostatic powder impact deposition method, an impact sintering method and so forth. The plasma protective film 53 is formed to fill among the low melting point alloy crystal grains 541. The plasma protective film 53 is formed on the base material 411 with a surface having a concave-convex structure by the low melting point alloy crystal grains 541. Therefore, the plasma protective film 53 having improved adhesion property to a base by an anchor effect is formed. With the above-mentioned processes, it is possible to obtain the shower head 41 in which the protective film 50 according to the third embodiment has been formed on the base material 411.

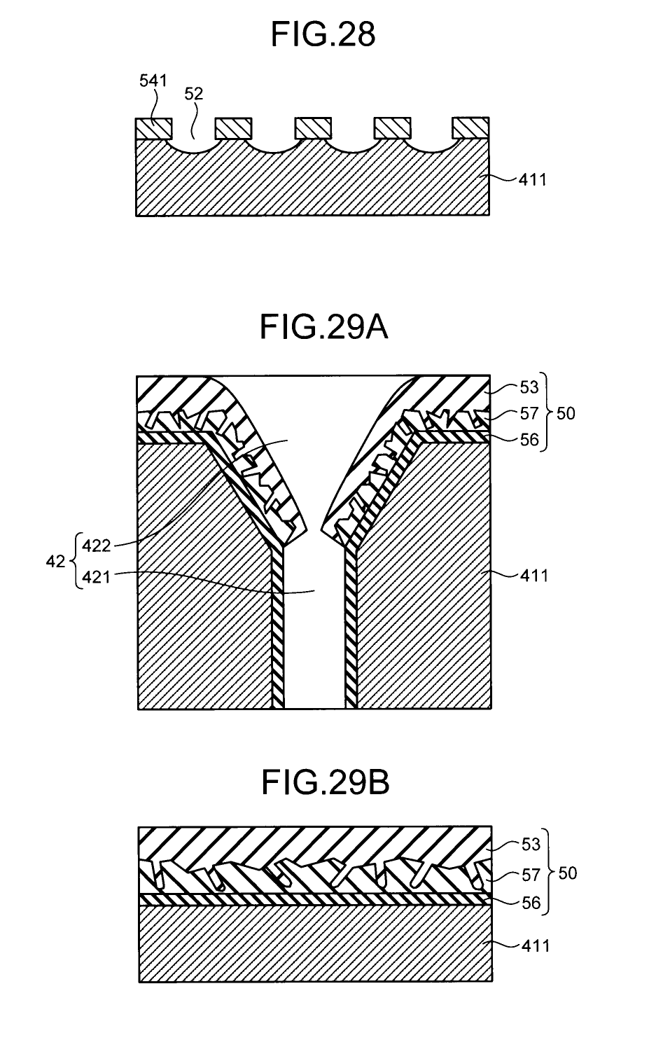

So far, in FIGS. 25A and 25B, after the Al crystal grains 542 of the aluminum alloy film 54 are removed through the wet etching process, the wet etching process is stopped. However, the embodiment is not limited thereto. FIG. 28 is a sectional view schematically illustrating another example of the procedure of a method for forming the protective film according to the third embodiment. As illustrated in FIG. 28, the wet etching process is not stopped at the time point at which the Al crystal grains 542 have been removed, and the base material 411 is also etched so that the adhesion property improvement grooves 52 may be formed in the base material 411. In such a case, since the base material 411 formed of a material including Al is easily etched as compared with the low melting point alloy crystal grains 541, the base material 411 is side-etched at the lower portion of edges of the low melting point alloy crystal grains 541. In this way, the etching process is performed until the adhesion property improvement grooves 52 are formed in the base material 411, resulting in a further increase of an anchor effect for the plasma protective film 53. In addition, when the base material 411 is etched, an etching time may be controlled.

Even in the third embodiment, similarly to the first embodiment, even when the plasma treatment is repeated and the plasma protective film 53 is exposed to plasma, it is possible to obtain the plasma protective film 53 which is hardly stripped off from the base material 411. Furthermore, the aluminum alloy film 54a is crystallized on the base material 411 to be divided into the low melting point alloy crystal grains 541 and the Al crystal grains 542, and the Al crystal grains 542 are molten using chemical, resulting in the achievement of the low melting point alloy crystal grains 541 distributed in an island shape on the exhaust port formation surface of the base material 411 and the inner surface of the exhaust port 422. Furthermore, the surface area of the base material 411 is increased by the low melting point alloy crystal grains 541. As a consequence, similarly to the first and second embodiments, it is not necessary to form the base film 51 and perform a patterning process.

### Fourth Embodiment

FIGS. 29A and 29B are partial sectional views schematically illustrating the structure of the shower head according to a fourth embodiment, wherein FIG. 29A is a sectional view schematically illustrating the structure in the vicinity of the exhaust port, and FIG. 29B is a partially enlarged sectional view of a protective film forming position. A first alumite film 56 is formed by an anodic oxidation process on the exhaust port formation surface of the base material 411 and the inner surface of the gas supply passage 42, which constitute the shower head 41. Furthermore, a second alumite film 57 having a columnar structure of an irregular shape as compared with Al is formed on the first alumite film 56 on the exhaust port formation surface of the base material 411 and the inner surface of the exhaust port 422. The second alumite film 57, for example, may use a material, such as Al—Si, Al—W, Al—Mo, Al—Ti or Al—Ta, which is hardly subject to an anodic oxidation process. A base film is formed by the first alumite film 56 and the second alumite film 57. Then, the plasma protective film 53 formed of alumina or yttria is formed on the second alumite film 57. In this way, the protective film 50 includes the first alumite film 56, the second alumite film 57, and the plasma protective film 53.

That is to say, in the fourth embodiment, the second alumite film 57 having the irregular columnar structure is formed on the exhaust port formation surface of the base material 411 and the inner surface of the exhaust port 422, resulting in an increase of the surface area of the base film and thus the achievement of an anchor effect for the plasma protective film 53 formed on the second alumite film 57.

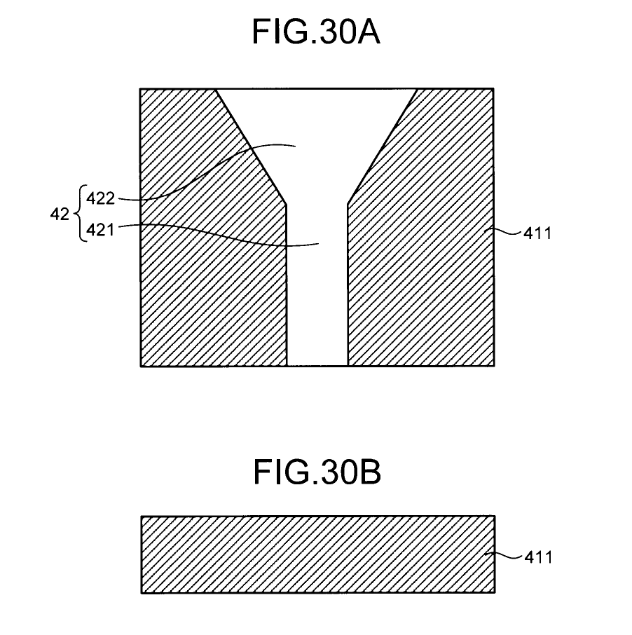

FIGS. 30A, 30B, 31A, 32B, 33A, 33B, 34A, 34B, 35A, and 35B are sectional views schematically illustrating an example of the procedure of a method for forming the protective film according to the fourth embodiment. Among these drawings, FIGS. 30A, 31A, 32A, 33A, 34A, and 35A are sectional views in the vicinity of the shower head, and FIGS. 30B, 31B, 32B, 33B, 34B, and 35B are enlarged sectional views of protective film forming positions.

First, as illustrated in FIGS. 30A and 30B, for example, the gas supply passage 42 including the gas flow channel 421 and the exhaust port 422 connected to the gas flow channel 421 is formed in the base material 411 formed of aluminum. Next, as illustrated in FIGS. 31A and 31B, an anodic oxidation process is performed to form the first alumite film 56 on the surface of the base material 411. In this way, a protective film including the first alumite film 56 is formed on the inner surface of the gas flow channel 421 on which the plasma protective film 53 is hardly formed.

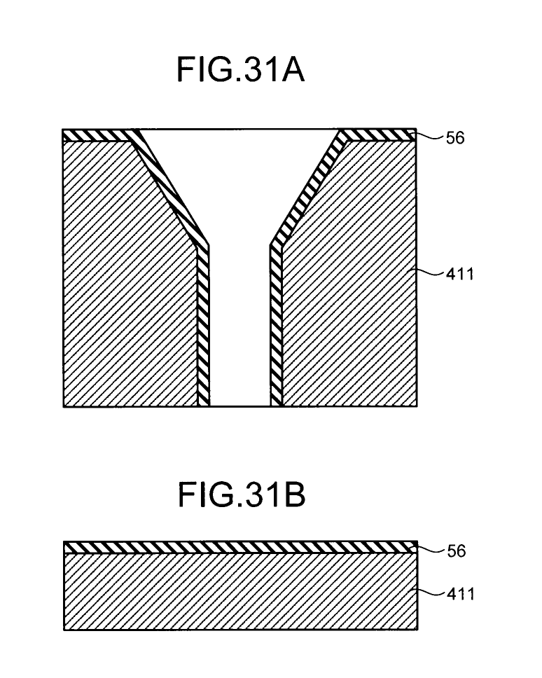

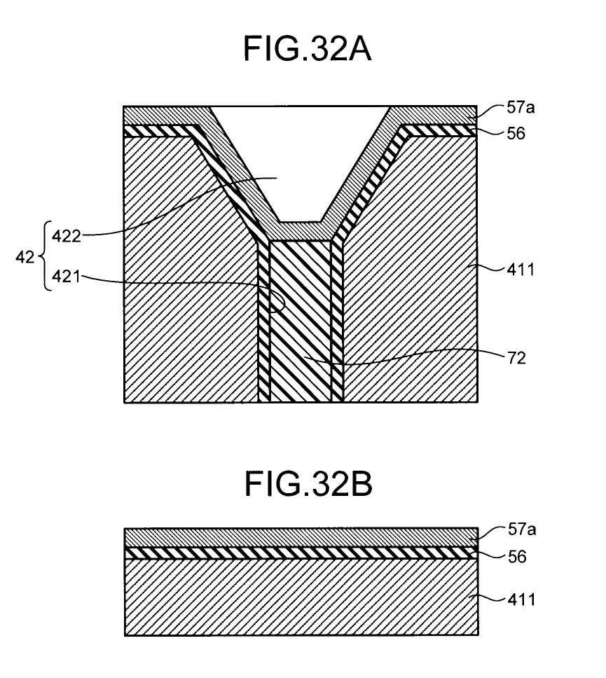

Then, as illustrated in FIGS. 32A and 32B, the gas flow channel 421 of the gas supply passage 42 is sealed by the seal material 72. The seal material 72 is filled only in the gas flow channel 421, and is not embedded in the exhaust port 422. Furthermore, as the seal material 72, for example, resist can be used.

Moreover, an aluminum alloy film 57a, which includes a material for forming a hollow columnar anodic oxidation film of an irregular shape by an anodic oxidation process, is formed on the surface of the exhaust port formation surface side of the base material 411, in detail, the exhaust port formation surface of the base material 411, the inner surface of the exhaust port 422, and the upper surface of the seal material 72 by using a film forming method such as a deposition method. As the aluminum alloy film 57a, for example, Al—Si, Al—W, Al—Mo, Al—Ti, Al—Ta and so forth can be used.

Then, as illustrated in FIGS. 33A and 33B, an anodic oxidation process is performed on the aluminum alloy film 57a to form the second alumite base film 57. The aluminum alloy film 57a is anodically oxidized to have an irregular hollow columnar shape, other than a regular hollow columnar shape as with the case in which Al has been subject to the anodic oxidation process. As a result, the surface area of the second alumite base film 57 is increased.

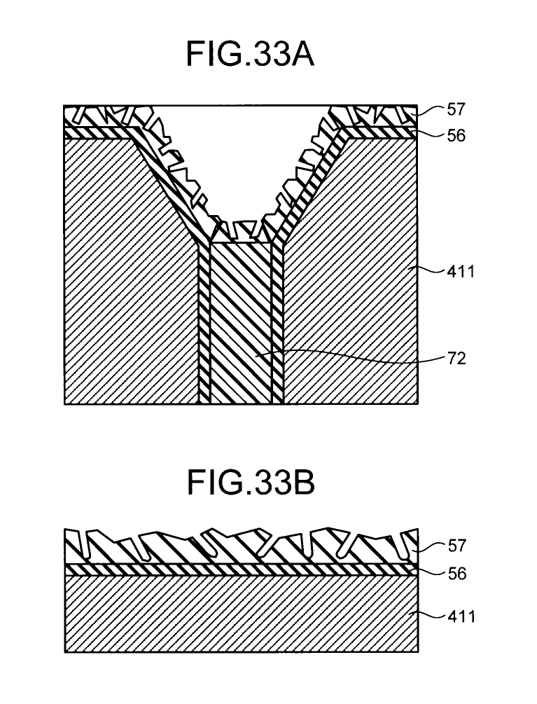

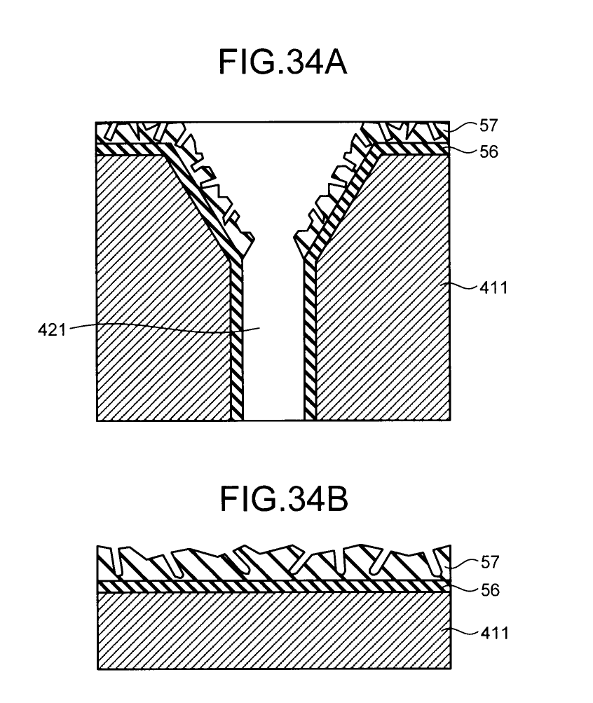

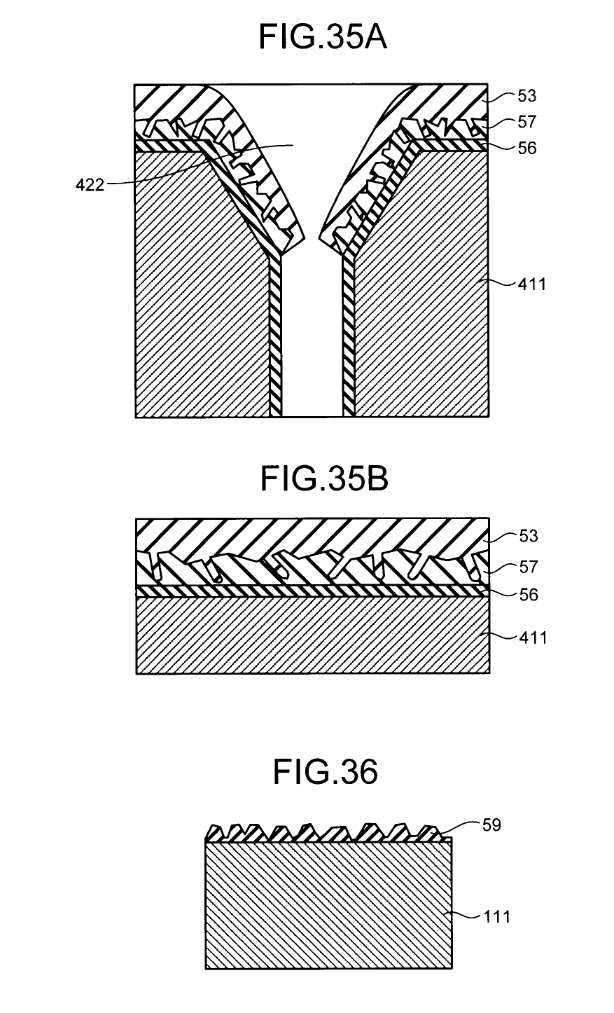

Thereafter, as illustrated in FIGS. 34A and 34B, the seal material 72 formed in the gas flow channel 421 is removed by a wet etching process. Then, as illustrated in FIGS. 35A and 35B, the plasma protective film 53 such as an alumina film or a yttria film is formed on the inner surface of the exhaust port 422 and the exhaust port formation surface of the base material 411, on which the second alumite base film 57 has been formed. As a method for forming the plasma protective film 53, for example, it is possible to use a spraying method, a CVD method, an aerosol deposition method, a cold spraying method, a gas deposition method, an electrostatic powder impact deposition method, an impact sintering method and so forth. The plasma protective film 53 is formed to fill in holes formed in the second alumite base film 57. A base film of the plasma protective film 53 is the second alumite base film 57 provided on the surface thereof with a concave-convex structure by the irregular holes, so that the adhesion property of the plasma protective film 53 formed on the base film is improved by an anchor effect. With the above-mentioned processes, it is possible to obtain the shower head 41 in which the protective film 50 according to the fourth embodiment has been formed on the base material 411.

Even in the fourth embodiment, similarly to the first embodiment, even when the plasma treatment is repeated and the plasma protective film 53 is exposed to plasma, it is possible to obtain the plasma protective film 53 which is hardly stripped off from the base material 411. Furthermore, the second alumite base film 57 having an irregular hollow columnar shape by the anodic oxidation process is provided, resulting in an increase of the surface area of the base film of the plasma protective film 53. As a consequence, similarly to the first and second embodiments, it is not necessary to form the base film 51 and perform a patterning process.

In addition, the shower head 41 also functions as an upper electrode of the plasma treatment apparatus, and includes a ground line and connection parts (not illustrated). When forming the protective film 50 described in the above embodiment, since it is difficult to form the protective film 50 formed of an insulation material on the connection parts, a mask is applied to the connection parts using resist and so forth.

### Fifth Embodiment

In a general plasma treatment apparatus, reaction products generated by an RIE process may be accumulated on the inner wall of the chamber 11, be stripped off from the inner wall of the chamber 11 during plasma treatment (RIE process) if the amount of the accumulated reaction products reaches a certain degree, and may fall on the wafer 100 as dust. In the fifth embodiment, the protective film 50 capable of solving such a problem will be described.

FIG. 36 is a sectional view schematically illustrating the structure of the protective film according to the fifth embodiment. As illustrated in FIG. 36, the surface of the base material 111 of the chamber 11 and so forth has been planarized, and a roughened alumite film 59 as the protective film 50 is formed on the surface of the base material 111. Preferably, the thickness of the alumite film 59 is about 10 μm to about 200 μm, and the surface of the alumite film 59 has a concave-convex structure of about 2 μm to about 100 μm in terms of arithmetic average roughness Ra.

In this way, the roughened alumite film 59 is formed on the surface of the base material 111, thereby preventing the base material 111 from being corroded by active species generated during the plasma treatment. Furthermore, the reaction products generated during the plasma treatment are accumulated on the roughened base material 111, resulting in an increase of the surface area of the alumite film 59 and an increase of an anchor effect due to the shape. Since reaction products formed on the alumite film 59 improve adhesion property to the alumite film 59, the reaction products are hardly stripped off therefrom.

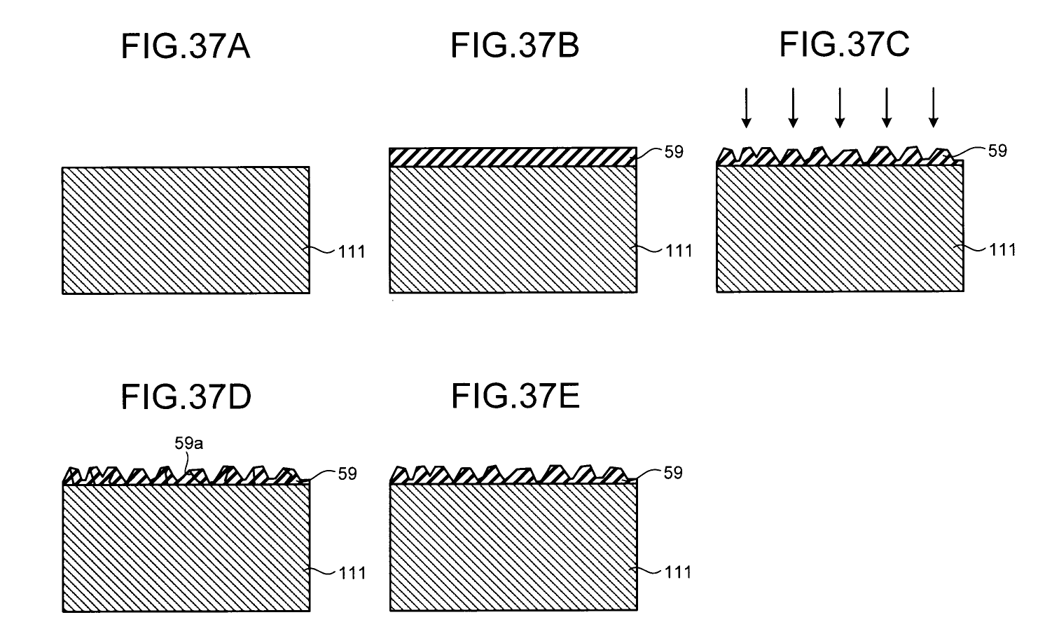

Next, a method for manufacturing the alumite film 59 will be described. FIGS. 37A to 37E are sectional views schematically illustrating an example of the procedure of a method for forming the protective film according to the fifth embodiment. First, as illustrated in FIG. 37A, prepared is the base material 111 formed of aluminum and having a planarized surface. Next, as illustrated in FIG. 37B, the alumite film 59 (an anodic oxidation film) having a hollow cell shape and a thickness of about 10 μm to about 200 μm is formed on the surface of the base material 111 by an anodic oxidation process using a sulfuric acid aqueous solution, a mixed aqueous solution of sulfuric acid and axalic acid, and so forth. In addition, a crack is hardly generated in an alumite film 59 formed by the anodic oxidation process using the mixed aqueous solution of sulfuric acid and axalic acid, as compared with an alumite film 59 formed by the anodic oxidation process using the sulfuric acid aqueous solution. In this regard, it is preferable to appropriately change an aqueous solution to be used in consideration of the probability of the generation of a crack at the formation position of the alumite film 59.

Then, as illustrated in FIG. 37C, the surface of the alumite film 59 is roughened by a method such as a sandblast method. At this time, the alumite film 59 is roughened such that the arithmetic average roughness Ra of the surface of the alumite film 59 is 2 μm to 100 μm. However, the roughening process is performed such that the concave structure does not reach the base material 111.

For an alumite film 59 formed at a place where no sudden change occurs in the temperature during the plasma treatment or a place other than corner-edges, or an alumite film 59 formed by the anodic oxidation method capable of preventing the generation of a crack as described above, even when the plasma treatment is repeated, since a crack is hardly generated, the procedure for forming the roughened alumite film 59 may be completed with the processes of FIGS. 37A to 37C.

Meanwhile, for an alumite film 59 formed at a place (e.g., a place in the vicinity of a plasma generation area) where a sudden change occurs in the temperature during the plasma treatment or a place (e.g., corner-edges) where stress is easily concentrated, or an alumite film 59 formed by an anodic oxidation method that allows the generation of a crack, when the plasma treatment is repeated, a crack is easily generated. In this regard, it is preferable to perform processes of FIGS. 37D and 37E as follows.

As illustrated in FIG. 37D, a crack is generated in the formed alumite film 59. As a process for generating the crack, for example, a process for heating and cooling the base material 111 is repeated a plurality of times, so that a crack 59a is generated in the alumite film 59 due to the thermal expansion coefficient difference between aluminum (the base material 111) and the alumite film 59. For example, the crack 59a is generated by repeating a plurality of times a cycle of increasing the temperature of the base material 111 from the room temperature to the temperature (100° C. to 200° C.) slightly higher than the maximum achieving temperature at the time of the plasma treatment, and then cooling the base material 111 up to the room temperature. In this way, the crack 59a is generated, so that stress occurring in the alumite film 59 is attenuated.

Then, as illustrated in FIG. 37E, a hole sealing process is performed to seal the crack 59a generated in the alumite film 59. As the hole sealing process, for example, the oxidation of the alumite film 59 is promoted using water vapor and so forth, thereby sealing the crack 59a. At this time, a hollow cell is also sealed. Consequently, the roughened alumite film 59 is formed.

FIG. 36 illustrates an example in which the roughened alumite film 59 is provided on the base material 111 having a planarized surface. However, the embodiment is not limited to the structure as illustrated in FIG. 36 if the roughened alumite film 59 is provided. FIG. 38 is a sectional view schematically illustrating another example of the structure of the protective film according the fifth embodiment. FIG. 38 illustrates an example in which the alumite film 59 is provided on a roughened base material 111. In such a case, preferably, the thickness of the alumite film 59 is about 10 μm to about 100 μm, and the surface of the alumite film 59 has a concave-convex structure of about 2 μm to about 100 μm in terms of arithmetic average roughness Ra. Even in such a structure, similarly to the example as illustrated in FIG. 36, reaction products accumulated on the surface of the alumite film 59 roughened during the plasma treatment is hardly stripped off because it makes close contact with the component by an anchor effect.

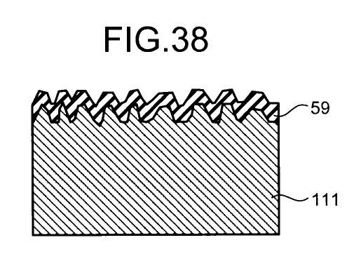

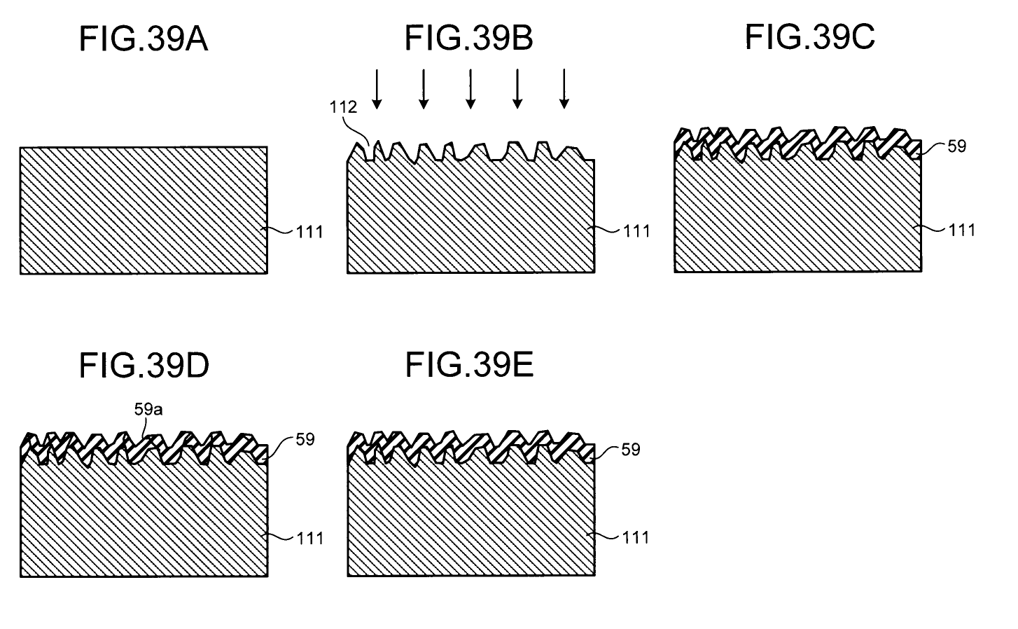

Next, a method for manufacturing the alumite film 59 will be described. FIGS. 39A to 39E are sectional views schematically illustrating another example of the procedure of a method for forming the protective film according to the fifth embodiment. First, as illustrated in FIG. 39A, prepared is the base material 111 formed of aluminum and having a planarized surface. Next, as illustrated in FIG. 39B, the surface of the base material 111 is roughened by a method such as a sandblast method. At this time, the surface of the base material 111 is roughened such that the arithmetic average roughness Ra of the surface after the alumite film 59 is formed is 2 μm to 100 μm.

Then, as illustrated in FIG. 39C, the alumite film 59 (an anodic oxidation film) having a hollow cell shape and a thickness of about 10 μm to about 100 μm is formed on the surface of the roughened base material 111 by an anodic oxidation process using a sulfuric acid aqueous solution, a mixed aqueous solution of sulfuric acid and axalic acid, and so forth. Similarly to the example of FIGS. 37A to 37C, when the alumite film 59 is formed at a place where a crack is hardly generated during the plasma treatment, or when the alumite film 59 is formed by the anodic oxidation method capable of preventing the generation of a crack as described above, the procedure for forming the roughened alumite film 59 may be completed with the processes of FIGS. 39A to 39C.

Meanwhile, when the alumite film 59 is formed at a place where a crack is easily generated during the plasma treatment, or an alumite film 59 is formed by an anodic oxidation method that allows the generation of a crack, it is preferable to perform processes of FIGS. 39D and 39E as follows.

As illustrated in FIG. 39D, a crack is generated in the formed alumite film. As a process for generating the crack, a method for repeating a plurality of times the heating and cooling of the base material 111 can be used similarly to the process illustrated in FIG. 37D. As a consequence, the crack 59a is generated in the alumite film 59.

Then, as illustrated in FIG. 39E, a hole sealing process is performed to seal the crack 59a generated in the alumite film 59. As the hole sealing process, for example, the oxidation of the alumite film 59 is promoted using water vapor and so forth, thereby sealing the crack 59a. At this time, a hollow cell is also sealed. Consequently, the roughened alumite film 59 is formed.

In addition, the roughened alumite film 59 can be provided to the surface of a component in an area where reaction products are accumulated. For example, the roughened alumite film can be provided to the surface of a component having a side making contact with a plasma generation area and the surface of the component up to the vicinity of the gas exhaust port 14 of the gas exhaust chamber 63.

In the fifth embodiment, after the surface of the component having the side making contact with the plasma generation area is roughened, the alumite film 59 is formed. Consequently, during the plasma treatment, due to the presence of the alumite film 59, active species generated in the plasma treatment are prevented from directly making contact with the component, so that the component is prevented from being corroded. Furthermore, since reaction products accumulated on the surface of the component during the plasma treatment are accumulated on the surface of the roughened alumite film 59, the reaction products are accumulated by making close contact with the component by an anchor effect. As a consequence, it is possible to prevent the reaction products from being stripped off from the component and falling on the wafer 100 during the plasma treatment.

Furthermore, in the above description, the RIE apparatus has been described as an example of the plasma treatment apparatus 10. However, it is possible to apply the above-described embodiments to all processing apparatuses such as a resist stripping apparatus, CDE (chemical dry etching) apparatus or a CVD apparatus, and all semiconductor manufacturing apparatuses.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A protective film formed on a component in a plasma treatment apparatus and having a plasma resistance, the protective film comprising:
a base film formed on the component and having a concave-convex structure; and
an upper film formed on the base film to cover the concave-convex structure.

2. The protective film according to claim 1,
wherein the component comprises:
a first surface; and
a second surface having an angle with respect to the first surface,
wherein the base film and the upper film are formed on the first surface and the second surface.

3. The protective film according to claim 1,
wherein the base film is formed of a stack film obtained by at least stacking a first film, a second film, and a third film,
the concave-convex structure includes a groove having a predetermined shape, which is formed in the base film with a depth so that the groove does not reach the component, and
the second film protrudes beyond the first film and the third film at a side constituting the groove.

4. The protective film according to claim 3,
wherein an anodic oxidation film is provided at portions of the first film and the third film, which make contact with the upper film.

5. The protective film according to claim 3,
wherein the component is formed of a material including Al,
the first film and the third film are formed of an Al film, and
the second film is formed of an Al—Si alloy film.

6. The protective film according to claim 1,
wherein the base film is formed of a stack film obtained by stacking a first film and a second film,
the concave-convex structure includes a groove having a predetermined shape, which is formed with a depth from the base film to the component, and
the first film protrudes beyond the component and the second film at a side constituting the groove.

7. The protective film according to claim 6,
wherein a portion of the second film, which make contact with the upper film, is an anodic oxidation film.

8. The protective film according to claim 1,
wherein the component is a base material having a plate shape and including a gas supply passage, and
the gas supply passage comprises:
a gas flow channel with a first diameter; and
an exhaust port which is connected to one end portion of the gas flow channel, has an opening diameter increasing from the end portion so as to be a second diameter larger than the first diameter, and is provided to a side of a main surface of a gas supply member,
wherein the base film is formed on the main surface of a formation side of the exhaust port of the component and a surface constituting the exhaust port.

9. The protective film according to claim 8,
wherein the groove is formed in a lattice shape on the main surface of the formation side of the exhaust port of the component, and is formed on the surface constituting the exhaust port in a radial manner from a center of the gas flow channel.

10. The protective film according to claim 1,
wherein the base film has a structure in which a plurality of island-shaped grains formed of a material different from a material of the component are dispersed on the component.

11. The protective film according to claim 10,
wherein a groove is formed in the component between adjacent grains, and enters into lower portions of edges of the grains.

12. The protective film according to claim 10,
wherein the component is formed of a material including Al, and
the grain includes one selected from the group consisting of Al—Sn, Al—Pb and Al—In.

13. The protective film according to claim 1,
wherein the base film includes a first anodic oxidation film formed of an alumite film, and a second anodic oxidation film formed of one selected from the group consisting of Al—Si, Al—W, Al—Mo, Al—Ti, and Al—Ta.

14. The protective film according to claim 1,
wherein the upper film includes an alumina film or an yttria-containing film.

15. The protective film according to claim 10,
wherein the component is a base material having a plate shape and including a gas supply passage, and
the gas supply passage comprises:
a gas flow channel with a first diameter; and
an exhaust port which is connected to one end portion of the gas flow channel, has an opening diameter increasing from the end portion so as to be a second diameter larger than the first diameter, and is provided to a side of a main surface of a gas supply member,
wherein the base film is formed on the main surface of a formation side of the exhaust port of the component and a surface constituting the exhaust port.

16. The protective film according to claim 8,
wherein the base film is formed on an inner surface of the gas flow channel, and
the concave-convex structure is formed only on the main surface of the formation side of the exhaust port of the component and the surface constituting the exhaust port.

17. A protective film formed on a component in a plasma treatment apparatus and having a plasma resistance, the protective film comprising:
an alumite film formed on a surface of the component and having a concave-convex structure.

18. A semiconductor manufacturing apparatus in which the protective film according to claim 1 is formed on a component.

19. A plasma treatment apparatus in which the protective film according to claim 1 is formed on a component.

20. A method of forming protective film formed on a component in a plasma treatment apparatus and having a plasma resistance, the method comprising:
forming a base film formed on the component and having a concave-convex structure; and
forming an upper film on the base film to cover the concave-convex structure.

21. The method of forming protective film according to claim 20,
wherein the component comprises:
a first surface; and
a second surface having an angle with respect to the first surface,
wherein in the forming of the base film and the forming of the upper film, the base film and the upper film are formed on the first surface and the second surface, respectively.

22. The method of forming protective film according to claim 20,
wherein the forming of the base film comprising:
stacking a first film, a second film, and a third film on the component sequentially;
processing the base film by performing a wet etching process to form a groove having a predetermined shape; and
performing an anodic oxidation process on the base film,
wherein in the processing the base film, the wet etching process is performed under a condition that an etching rate of the second film is lower than etching rates of the first and third films.

23. The method of forming protective film according to claim 20,
wherein the forming of the base film comprising:
stacking a first film and a second film on the component;
processing the base film and the component by performing a wet etching process to form a groove having a predetermined shape and a depth reaching the component; and
performing an anodic oxidation process on the component and the base film,
wherein in the processing the base film, the wet etching process is performed under a condition that an etching rage of the first film is lower than etching rates of the component and the second film.

24. The method of forming protective film according to claim 20,
wherein the forming of the base film comprising:
forming an Al alloy film having a melting point of about several hundred degrees Celsius on the component;
heating the Al alloy film at a temperature of about 200° C. and to segregate a low melting point metal included in the Al alloy film, thereby forming an Al alloy film including Al crystal grains formed of Al and Al alloy crystal grains; and
removing the Al crystal grains using a wet etching process.

25. The method of forming protective film according to claim 24,
wherein the component is formed of a material including Al, and
in the removing the Al crystal grains, etching the component from an area including no Al crystal grains in addition to the removing the Al crystal grains.

26. The method of forming protective film according to claim 23 further comprising:
performing an anodic oxidation process is performed, after the removing the Al crystal grains is performed.

27. The method of forming protective film according to claim 20,
wherein the forming of the base film comprising:
forming an alumite film on the component;
forming an Al alloy film including a metal which is hardly subject to an anodic oxidation process; and
anodically oxidizing the Al alloy film to form an anodic oxidation film having an irregular hollow columnar shape.

28. The method of forming protective film according to claim 20,
wherein the component is a base material having a plate shape and including a gas supply passage, and
the gas supply passage comprises:
a gas flow channel with a first diameter; and
an exhaust port which is connected to one end portion of the gas flow channel, has an opening diameter increasing from the end portion so as to be a second diameter larger than the first diameter, and is provided to a side of a main surface of a gas supply member,
wherein the forming of the base film comprising:
forming the base film on a surface constituting the exhaust port, the main surface of a formation side of the exhaust port, and an inner surface of the gas flow channel, and forming the concave-convex structure on the base film on the surface constituting the exhaust port and the main surface of the formation side of the exhaust port, and
the forming of the upper film comprising:
forming the upper film only on the surface constituting the exhaust port and the main surface of the formation side of the exhaust port.
